(19) United States
(12) Patent Application Publication
(10) Pub. No.: US 2016/0131902 A1
(43) Pub. Date: May 12, 2016

(54) SYSTEM FOR AUTOMATIC EYE TRACKING CALIBRATION OF HEAD MOUNTED DISPLAY DEVICE

(71) Applicants: Anthony J. Ambrus, Seattle, WA (US); Stephen G. Latta, Seattle, WA (US); Roger Sebastian-Kevin Sylvan, Seattle, WA (US); Adam G. Poulos, Sammamish, WA (US)

(72) Inventors: Anthony J. Ambrus, Seattle, WA (US); Stephen G. Latta, Seattle, WA (US); Roger Sebastian-Kevin Sylvan, Seattle, WA (US); Adam G. Poulos, Sammamish, WA (US)

(21) Appl. No.: 14/539,736

(22) Filed: Nov. 12, 2014

(51) Int. Cl. G02B 27/00; G06F 3/01; G02B 27/01

(52) U.S. Cl. CPC G02B 27/0093; G02B 27/017; G06F 3/013; G02B 2027/014; G02B 2027/0138

(57) ABSTRACT

A method of automatically calibrating a head mounted display for a user is disclosed. The method includes automatically calculating an inter-pupillary distance value for the user, comparing the automatically calculated inter-pupillary distance value to a previously determined inter-pupillary distance value, determining if the automatically calculated inter-pupillary distance value matches the preexisting inter-pupillary distance value, and automatically calibrating the head mounted display using calibration data associated with matching previously determined inter-pupillary distance value.

Mixed reality is a technology that allows holographic, or virtual, imagery to be mixed with a real world physical environment. A see-through, head mounted display device may be worn by a user to view the mixed imagery of real objects and virtual objects displayed in the user's field of view.

A head mounted display device may include eye tracking technology to track the position of the user's eyes. To accurately use the eye tracking technology, a user performs an eye tracking calibration process to generate eye tracking calibration data. The eye tracking calibration data are unique to each user, and may be time-consuming to create.

In many instances, multiple users may use a single head mounted display device. For example, members of a family or a group of friends may share one or more head mounted display devices. It is desirable that a head mounted display device may be easily shared between multiple users without having to perform eye tracking calibration each time the head mounted display device is passed from user to user.

### SUMMARY

In an example, the present technology relates to a method of automatically calibrating a head mounted display device for a user, the method comprising automatically calculating an inter-pupillary distance value for the user, comparing the automatically calculated inter-pupillary distance value to a previously determined inter-pupillary distance value, determining if the automatically calculated inter-pupillary distance value matches the preexisting inter-pupillary distance value, and automatically calibrating the head mounted display device using calibration data associated with matching previously determined inter-pupillary distance value.

In a further example, the present technology relates to a head mounted display device that includes an eye position and tracking assembly and a processor. The eye position and tracking assembly is configured to automatically calculate an inter-pupillary distance value for the user. The processor is configured to compare the automatically calculated inter-pupillary distance value to a previously determined inter-pupillary distance value, determine if the automatically calculated inter-pupillary distance value matches, within a predetermined tolerance, the preexisting inter-pupillary distance value, and automatically calibrate the head mounted display device using calibration data associated with matching previously determined inter-pupillary distance value.

In another example, the present technology relates to an apparatus that includes a computer system and a head-mounted display device. The computer system provides an electronic signal representing image data. and the head-mounted display device provides image data in response to the electronic signal. The head-mounted display device includes an eye position and tracking assembly and a processor. The eye position and tracking assembly is configured to automatically calculate an inter-pupillary distance value for the user. The processor is configured to compare the automatically calculated inter-pupillary distance value to a previously determined inter-pupillary distance value, determine if the automatically calculated inter-pupillary distance value matches, within a predetermined tolerance, the preexisting inter-pupillary distance value, and automatically calibrate the head mounted display device using calibration data associated with matching previously determined inter-pupillary distance value.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### BRIEF DESCRIPTION OF THE DRAWINGS

FIG. 1 illustrates example components of an embodiment of a system for presenting a mixed reality environment to one or more users.

FIG. 2 is a perspective view of an embodiment of a head mounted display unit.

FIG. 3 is a top view of a portion of an embodiment of a head mounted display unit.

FIG. 4 is a block diagram of an embodiment of components of a head mounted display unit.

FIG. 5 is a block diagram of an embodiment of components of a processing unit associated with a head mounted display unit.

FIG. 6 is a block diagram of an embodiment of components of a hub computing system used with a head mounted display unit.

FIG. 7 is a block diagram of an embodiment of a computing system that can be used to implement the hub computing system described herein.

FIG. 8 is a flowchart illustrating an embodiment of an eye tracking calibration identification process.

FIG. 9A is a diagram illustrating an example database of previous user data.

FIG. 9B is another diagram illustrating an example database of previous user data.

FIG. 10 is a flowchart illustrating an embodiment of a new user calibration process.

FIG. 11 is a flowchart illustrating an embodiment of a user-identification process.

FIG. 12 is a flowchart illustrating an embodiment of a visual detection process.

FIG. 13 is a diagram depicting an embodiment of a user-identification display image.

### DETAILED DESCRIPTION

Embodiments of the present technology automatically calibrate a head mounted display device. When a user puts on a head mounted display device, sensors in the device automatically calculate an interpupillary distance (“IPD”) value for the user. The head mounted display device uses the automatically calculated IPD value to identify the user, and retrieve stored eye tracking calibration data associated with the identified user.

In particular, if the automatically calculated IPD value uniquely matches a previously determined IPD value, the head mounted display device retrieves stored eye tracking calibration data associated with the uniquely matching previously determined IPD value. If the automatically calculated IPD value matches more than one previously determined IPD value, the head mounted display device disambiguates to determine which of the multiple matching previously determined IPD values corresponds to the user, and retrieves stored eye tracking calibration data associated with the disambiguated previously determined IPD value. The head mounted display device is automatically calibrated using the retrieved eye tracking calibration data.

A head mounted display device may be used to implement a mixed reality environment including real and virtual objects. The head mounted display device may include a display element. The display element may be transparent so that a user can look through the display element at real world objects within the user's field of view (FOV). The display element also provides the ability to project virtual images into the FOV of the user such that the virtual images may also appear alongside the real world objects. The system automatically tracks where the user is looking so that the system can determine where to insert the virtual image in the FOV of the user. Once the system knows where to project the virtual image, the image is projected using the display element.

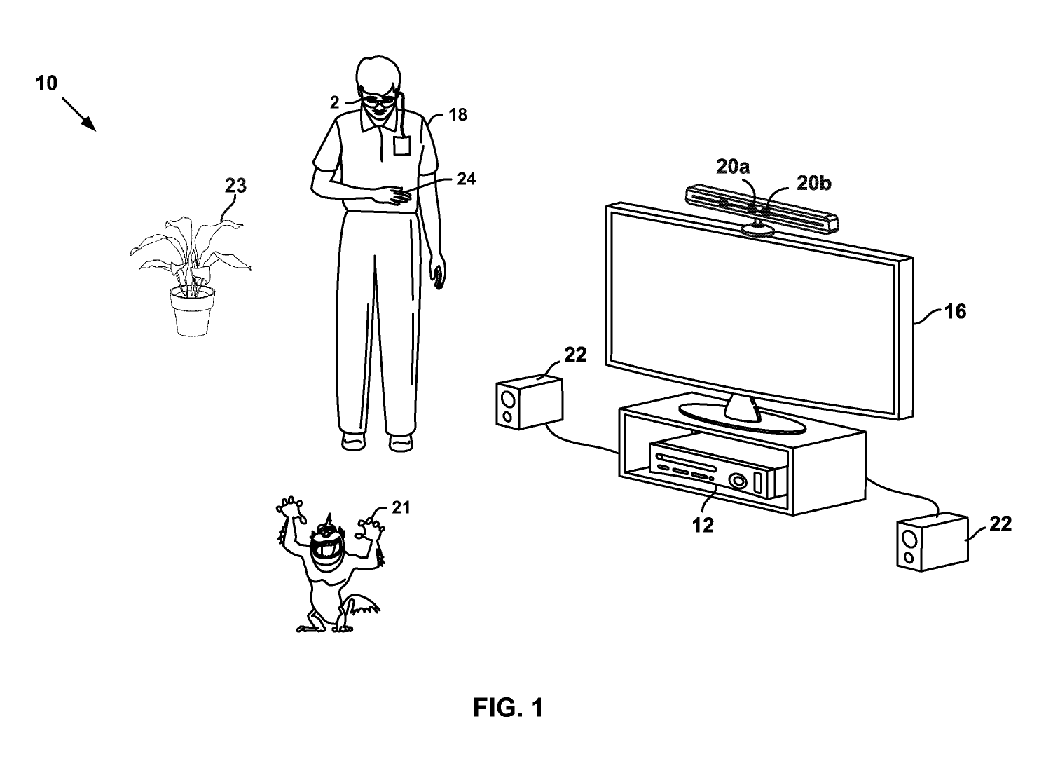

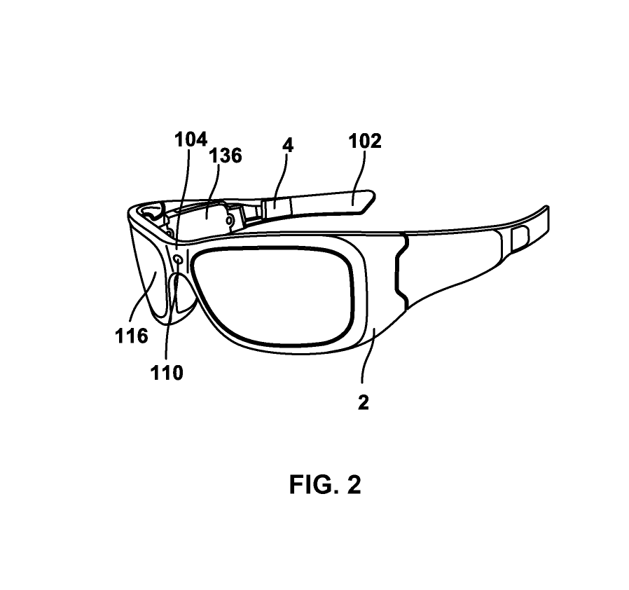

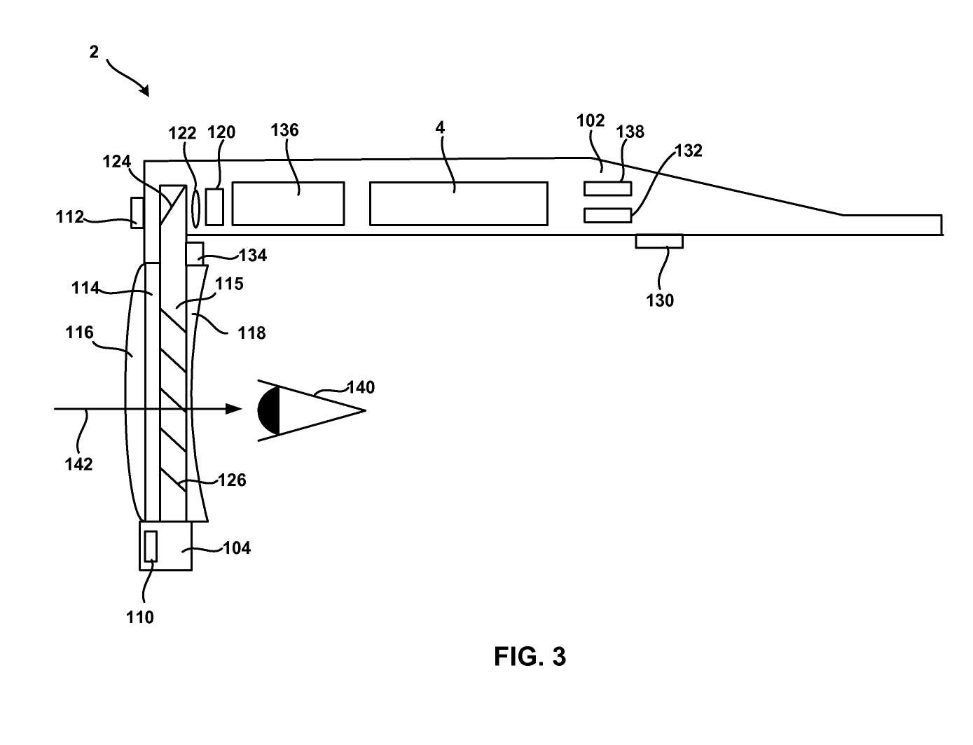

FIG. 1 illustrates a system 10 for providing a mixed reality experience by fusing a virtual object 21 with real content within a user's FOV. FIG. 1 shows a user 18 wearing a head mounted display device 2 for viewing virtual objects such as virtual object 21. In other embodiment, there may be more than one user 18, each wearing a corresponding head mounted display device 2. As depicted in FIGS. 2 and 3, head mounted display device 2 may include an integrated processing unit 4. In other embodiments, processing unit 4 may be separate from head mounted display device 2, and may communicate with head mounted display device 2 via wired or wireless communication. For example, in some embodiments, processing unit 4 may be in a separate unit which may be worn on the body or clothing of user 18, e.g., the wrist, arm, chest or in a pocket.

Head mounted display device 2, which in one embodiment is in the shape of eyeglasses, is worn on the head of user 18 so that user 18 can see through a display and thereby have an actual direct view of the space in front of the user. The use of the term “actual direct view” refers to the ability to see the real world objects directly with the human eye, rather than seeing created image representations of the objects. For example, looking through glass at a room allows a user to have an actual direct view of the room, whereas viewing a video of a room on a television is not an actual direct view of the room. More details of head mounted display device 2 are provided below.

Processing unit 4 may include much of the computing power used to operate head mounted display device 2. In embodiments, processing unit 4 communicates wirelessly (e.g., WiFi, near-field communication (NFC), Bluetooth, infra-red (IR), or other wireless communication means) to one or more hub computing systems 12. As explained hereinafter, hub computing system 12 may be provided remotely from processing unit 4, so that hub computing system 12 and processing unit 4 communicate via a wireless network such as a LAN or WAN. In other embodiments, hub computing system 12 may be omitted to provide a mobile mixed reality experience using head mounted display devices 2 and processing units 4.

Head mounted display device 2, either by itself or in conjunction with hub computing system 12, may provide a mixed reality experience where one or more virtual images, such as virtual object 21 in FIG. 1, may be mixed together with real world objects in a scene. FIG. 1 illustrates examples of a plant 23 or a user's hand 24 as real world objects appearing within the FOV of user 18.

Hub computing system 12 may be a computer, a gaming system or console, or the like. In an embodiment, hub computing system 12 may include hardware components and/or software components such that hub computing system 12 may be used to execute applications such as gaming applications, non-gaming applications, or the like. An application may be executing on hub computing system 12, head mounted display device 2, a mobile device or a combination of these.

In an embodiment, hub computing system 12 further includes one or more capture devices, such as capture devices 20a and 20b, which may be used to capture the room or other physical environment of user 18, but are not necessary for use with head mounted display device 2 in all embodiments. Capture devices 20a and 20b may be, for example, cameras that visually monitor one or more users 18 and the surrounding space such that gestures and/or movements performed by one or more users 18, as well as the structure of the surrounding space, may be captured, analyzed, and tracked to perform one or more controls or actions within an application and/or animate an avatar or on-screen character.

Hub computing system 12 may be connected to an audiovisual device 16 such as a television, a monitor, a tablet computer, a high-definition television (HDTV), or the like that may provide game or application visuals. In some embodiments, audiovisual device 16 may be a three-dimensional display device. Audiovisual device 16 may include internal speakers (not shown), and/or may be connected to external speakers 22.

In various embodiments, the processes described herein are performed in whole or in part by head mounted display device 2, processing unit 4, hub computing system 12, or a combination thereof. Note that head mounted display device 2 and processing unit 4 can be used without hub computing system 12, in which case processing unit 4 will communicate with a WiFi network, a cellular network or other communication means.

In some embodiments, various sensor technologies embedded in head mounted display device 2, including accelerometers and gyroscopes, global positioning systems, and eye tracking elements, may be used to determine a view direction of user 18. User view direction means where the user is looking or what has the user's attention.

A user's view direction can be determined by head orientation and/or eye gaze. In some cases, head orientation and eye gaze are directed at the same point, and in other cases head orientation and eye gaze are directed at different points. For example, a user's head may be oriented in one direction (e.g., straight ahead), but their eye gaze may be in a different direction (e.g., off to the left). In such a case, head orientation may be used to define the view direction. Alternatively, the eye gaze could be used to determine the user's view direction when the two differ. As described in more detail below, various sensor technologies embedded in head mounted display device 2 may be used to determine a view direction of a user.

Other techniques may be used to determine the user's view direction. Such techniques could include time of flight, spatial scan, mechanical linkages, phase-difference sensing, and/or direct field sensing. In such cases, additional hardware may be included in head mounted display 2.

In an embodiment, hub computing device 12 may be used to track user 18 and head mounted display device 2 to provide a preliminary determination of location and orientation of head mounted display device 2. Various sensor technologies may be implemented in hub computing device 12 including RGB camera, depth sensor, and/or other technologies to determine location and orientation of head mounted display device 2.

Additional information, such as information retrieved from the cloud, information detected and/or gathered by one or more external devices, and other information also may be used to identify and continuously track the user's head position and rotation. Techniques such as Simultaneous Localization and Mapping (SLAM) using RGB and/or depth sensor data may be employed to provide a real-time position of the user's head relative to the mapped environment. Environmental typography may be identified using data from the cloud and/or depth sensor data. Regions of the user's body also can be identified (e.g., hand, arm, torso, legs) using depth sensor data.

Not all sensor information and/or sensing technologies discussed above are required at all times. One or more sensors may be used as redundancies to further refine the measurement of the total field of view of the user.

FIGS. 2 and 3 show various views of head mounted display device 2. FIG. 3 shows a top view of the right side of head mounted display device 2, including a portion of the device having a temple 102 and a nose bridge 104. A microphone 110 is built into nose bridge 104 for recording sounds and transmitting audio data to processing unit 4, as described below. At the front of head mounted display device 2 is room-facing camera 112 that can capture video and still images. Those images are transmitted to processing unit 4, as described below.

In an embodiment, room-facing camera 112 is a depth camera that may capture a depth image of a scene. A depth image may include a two-dimensional (2-D) pixel area of the captured scene where each pixel in the 2-D pixel area may represent a depth value such as a distance in, for example, centimeters, millimeters, or the like of an object in the captured scene. For example, the depth camera may include an IR illuminator transmitter and a hot reflecting surface like a hot mirror in front of the visible image sensor which lets the visible light pass and directs reflected IR radiation within a wavelength range transmitted by the illuminator to a CCD or other type of depth sensor. The data from the sensors may be sent to processing unit 4 or hub computing system 12 for processing. The processing identifies and maps the user's real world field of view. Additionally, room-facing camera 112 also may include a light meter for measuring ambient light.

A portion of the frame of head mounted display device 2 surrounds a display that includes one or more lenses. To depict the components of head mounted display device 2, a portion of the frame surrounding the display is not depicted. The display includes light-guide optical element 115, opacity filter 114, see-through lens 116 and see-through lens 118. In one embodiment, opacity filter 114 is behind and aligned with see-through lens 116, light-guide optical element 115 is behind and aligned with opacity filter 114, and see-through lens 118 is behind and aligned with light-guide optical element 115. See-through lenses 116 and 118 are standard lenses used in eyeglasses and can be made to any prescription (including no prescription).

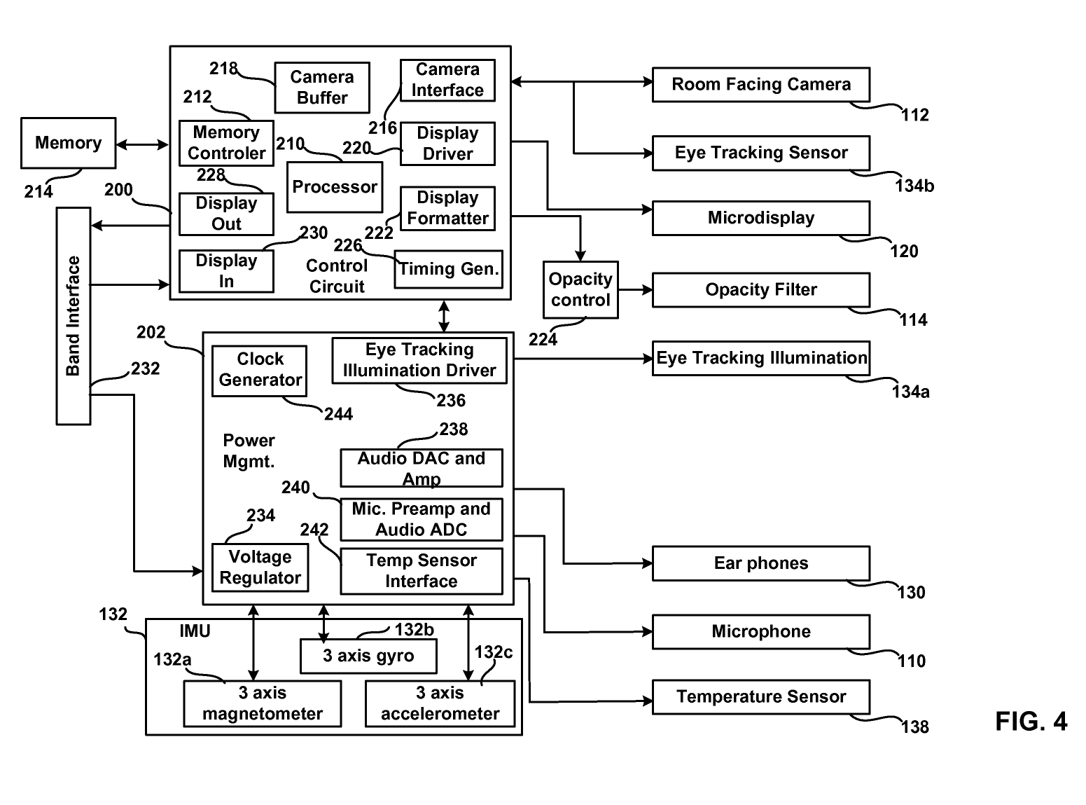

Control circuits 136 provide various electronics that support other components of head mounted display device 2. More details of control circuits 136 are provided below with respect to FIG. 4. Inside or mounted to temple 102 are earphones 130, inertial measurement unit 132 and temperature sensor 138. In one embodiment shown in FIG. 4, inertial measurement unit 132 (or IMU 132) includes inertial sensors such as a three axis magnetometer 132a, three axis gyro 132b and three axis accelerometer 132c. IMU 132 senses position, orientation, and sudden accelerations (pitch, roll and yaw) of head mounted display device 2. IMU 132 may include other inertial sensors in addition to or instead of magnetometer 132a, gyro 132b and accelerometer 132c.

Microdisplay 120 projects an image through lens 122. Various image generation technologies can be used to implement microdisplay 120. For example, microdisplay 120 can be implemented using a transmissive projection technology where the light source is modulated by optically active material, backlit with white light. These technologies are usually implemented using LCD type displays with powerful backlights and high optical energy densities.

Microdisplay 120 also can be implemented using a reflective technology for which external light is reflected and modulated by an optically active material. The illumination is forward lit by either a white source or RGB source, depending on the technology. Digital light processing (DLP), liquid crystal on silicon (LCOS) and Mirasol® display technology from Qualcomm, Inc. are all examples of reflective technologies which are efficient, as most energy is reflected away from the modulated structure and may be used in the present system.

Additionally, microdisplay 120 can be implemented using an emissive technology where light is generated by the display. For example, a PicoP™ display engine from Microvision, Inc. emits a laser signal with a micro mirror steering either onto a tiny screen that acts as a transmissive element or beamed directly into the eye (e.g., laser).

Light-guide optical element 115 transmits light from microdisplay 120 to the eye 140 of user 18 wearing head mounted display device 2. Light-guide optical element 115 also allows light from in front of head mounted display device 2 to be transmitted through light-guide optical element 115 to eye 140, as depicted by arrow 142. In this regard, user 18 can have an actual direct view of the space in front of head mounted display device 2, and also receive a virtual image from microdisplay 120. Thus, the walls of light-guide optical element 115 are see-through.

Light-guide optical element 115 includes a first reflecting surface 124 (e.g., a mirror or other surface). Light from microdisplay 120 passes through lens 122 and becomes incident on reflecting surface 124. First reflecting surface 124 reflects the incident light from the microdisplay 120 such that light is trapped inside a planar substrate comprising light-guide optical element 115 by internal reflection. After several reflections off the surfaces of the substrate, the trapped light waves reach an array of selectively reflecting surfaces 126.

One of the five surfaces is labeled 126 to prevent over-crowding of the drawing. Reflecting surfaces 126 couple the light waves incident upon those reflecting surfaces out of the substrate into eye 140 of the user. More details of a light-guide optical element can be found in U.S. Patent Publication No. 2008/0285140, entitled “Substrate-Guided Optical Devices,” published on Nov. 20, 2008.

In an embodiment, each eye will have its own light guide optical element 115. If head mounted display device 2 has two light guide optical elements, each eye can have its own micro display 120 that can display the same image in both eyes or different images in the two eyes. In another embodiment, a single light guide optical element 115 may be used to reflect light into both eyes.

Opacity filter 114, which is aligned with light guide optical element 115, selectively blocks natural light, either uniformly or on a per-pixel basis, from passing through light guide optical element 115. In an embodiment, opacity filter 114 can be a see-through LCD panel, electro chromic film, PDLC (Polymer Dispersed Liquid Crystal) or similar device which is capable of serving as an opacity filter. Such a see-through LCD panel can be obtained by removing various layers of substrate, backlight and diffusers from a conventional LCD. The LCD panel can include one or more light-transmissive LCD chips which allow light to pass through the liquid crystal. Such chips are used in LCD projectors, for instance.

Opacity filter 114 can include a dense grid of pixels, where the light transmissivity of each pixel is individually controllable between minimum and maximum transmissivities. In some embodiments, the transmissivity range may be between 0-100%, although more limited ranges also are acceptable. As an example, a monochrome LCD panel with no more than two polarizing filters is sufficient to provide an opacity range of about 50% to 99% per pixel, up to the resolution of the LCD. At the minimum of 50%, the lens will have a slightly tinted appearance, which is tolerable. 100% transmissivity represents a perfectly clear lens. An “alpha” scale can be defined from 0-100%, where 0% allows no light to pass and 100% allows all light to pass. The value of alpha can be set for each pixel by the opacity control circuit 224 described below.

A mask of alpha values can be used from a rendering pipeline, after z-buffering with proxies for real-world objects. When the system renders a scene for the augmented reality display, it takes note of which real-world objects are in front of which virtual objects. If a virtual object is in front of a real-world object, then the opacity should be ON for the coverage area of the virtual object. If the virtual is (virtually) behind a real-world object, then the opacity should be OFF, as well as any color for that pixel, so the user will only see the real-world object for that corresponding area (a pixel or more in size) of real light.

Coverage would be on a pixel-by-pixel basis, so the system could handle the case of part of a virtual object being in front of a real-world object, part of the virtual object being behind the real-world object, and part of the virtual object being coincident with the real-world object. Displays capable of going from 0% to 100% opacity at low cost, power, and weight may be used. Moreover, opacity filter 114 can be rendered in color, such as with a color LCD or with other displays such as organic LEDs, to provide a wide field of view. More details of an opacity filter are provided in U.S. patent application Ser. No. 12/887,426, “Opacity Filter For See-Through Mounted Display,” filed on Sep. 21, 2010.

Head mounted display device 2 also may include a system for locating and tracking the position of the user's eyes and eye gaze (a point at which a user's eyes are momentarily fixed). In an embodiment, this system includes an eye position and tracking assembly 134 (FIG. 3), which includes an eye tracking illumination device 134a and eye tracking sensor 134b (FIG. 4). In one embodiment, eye tracking illumination device 134a includes one or more IR emitters, which emit IR light toward the eye. In one embodiment, eye tracking sensor 134b includes one or more cameras that sense the reflected IR light. Alternatively, eye tracking sensor 134b may be an RGB or depth sensor. There may be multiple sensors 134b in embodiments.

The position of a user's eyes, and the pupils within the eyes, can be identified by known imaging techniques which detect the reflection of the cornea. For example, see U.S. Pat. No. 7,401,920, entitled “Head Mounted Eye Tracking and Display System,” issued Jul. 22, 2008. Such a technique can locate a position of the center of the eye relative to eye tracking sensor 134b. In embodiments, separate eye position and tracking assembly 134 are used for each of the left and right eyes so that a user's IPD may be determined.

In an embodiment, the system uses four IR LEDs and four IR photo detectors in rectangular arrangement so that there is one IR LED and IR photo detector at each corner of the lens of head mounted display device 2. Light from the LEDs reflect off the eyes. The amount of IR light detected at each of the four IR photo detectors determines a position of the eye relative to eye tracking sensor 134b, as well as the pupil direction. In particular, the amount of white versus black in the eye will determine the amount of light reflected off the eye for that particular photo detector. Thus, the photo detector will have a measure of the amount of white or black in the eye. From the four samples, the system can determine the direction of the eye.

Another alternative is to use four IR LEDs as discussed above, but one IR CCD on the side of the lens of head mounted display device 2. The CCD will use a small mirror and/or lens (fish eye) such that the CCD can image up to 75% of the visible eye from the eyeglass frame. The CCD will then sense an image and use computer vision to find the image, much like as discussed above. Thus, although FIG. 3 shows one assembly with one IR transmitter, the structure of FIG. 3 can be adjusted to have four IR transmitters and/or four IR sensors. More or less than four IR transmitters and/or four IR sensors also can be used.

Another embodiment for tracking the direction of the eyes is based on charge tracking. This concept is based on the observation that a retina carries a measurable positive charge and the cornea has a negative charge. Sensors are mounted by the user's ears (near earphones 130) to detect the electrical potential while the eyes move around and effectively read out what the eyes are doing in real time. This provides both the position of a user's eyes relative to the head mounted display device, and the position of the user's pupils. Other embodiments for tracking eyes can also be used, such as those described in U.S. Patent Publication NO. 2012/0154277, “Optimized Focal Area for Augmented Reality Displays,” filed on Dec. 17, 2010.

Using any of the above-described embodiments, the eye position and tracking assembly 134 is able to determine a position of the user's left and right eyes relative to a position of eye position and tracking assembly 134. Using the known position and geometry of eye position and tracking assembly 134 relative to light-guide optical elements 115, the position of light-guide optical elements 115 relative to the user's left and right eyes also is known. This position includes a relative position of the eyes and the optical elements along an x-axis (e.g., horizontal positioning), a relative position of the eyes and optical elements along a y-axis (e.g., vertical positioning), and a relative position of the eyes and optical elements along a z-axis (e.g., a distance between the eyes and optical elements).

Once eye position and tracking assembly 134 determines a position of the user's left and right eyes relative to a position of eye position and tracking assembly 134 and relative to light-guide optical elements 115, it is also advantageous to determine the angular orientation (pitch, yaw and roll) of light-guide optical elements 115 relative to the left and right eyes. For this purpose, eye position and tracking assembly 134 also determines a center of each eye, and an eye vector straight out from the center of the eye.

The eye center may be determined in a number of ways. Where eye tracking sensor 134b captures an image of the eye (either as a color image and/or as a depth image), the image may be analyzed to determine the eye center. For example, an image sensor may examine the corneal surface, and from that, determine major axes and the corneal center. In a further embodiment, the image sensor may examine other features of the eyes, including pupil, sclera (white portions of the eye) and/or eye lashes and eye color. Other features of the face such as brow, nose and nose bridge may further be imaged and used to determine the centers of the left and right eyes. A user's IPD may be determined based on determination of the center of each eye.

Examples including IR transmitters/receivers also may determine the center of the eye and an eye vector straight out from the center. For example, where there are multiple IR transmitters/receivers, such as four, each of these components may measure the amount of sclera in the eye they detect. These four independent values may be determined and compared. When each measures the same amount of sclera in the eye, the eye is centered (looking straight forward), and the eye vector may be taken perpendicularly straight out from the pupil. This position may either be found when each IR transmitter/receiver measures the same amount of sclera in the eye, or it may be extrapolated from a measurement where the four transmitter/receiver pairs measure different values of sclera in the eye. The eye vector may be used as a measure of the user's eye gaze (a point at which a user's eyes are momentarily fixed)

In addition to determining a position of the user's left and right eyes relative to a position of light-guide optical elements 115, and the angular orientation of light-guide optical elements 115 relative to the left and right eyes, it also is advantageous to determine a user's eye gaze (a point at which a user's eyes are momentarily fixed). To accurately track a user's eye gaze, a user of head mounted display device 2 typically performs and eye tracking calibration to map detected gaze positions to corresponding positions on light-guide optical elements 115.

For example, in an embodiment, light-guide optical elements 115 may transmit one or more images to the eyes of a user wearing head mounted display device 2, and for each transmitted image, the user is instructed to “look at” the transmitted image, and eye position and tracking assembly 134 determines the user's eye gaze. Processing unit 4 may then calibrate and map the detected eye gaze data to the position of the corresponding images transmitted by light-guide optical elements 115.

In some embodiments, this calibration step may require the user to “look at” a large number of transmitted images to accurately calibrate the eye tracking data with light-guide optical elements 115. In an embodiment, eye position and tracking assembly 134 determines eye tracking calibration data for the user wearing head mounted display device 2. The determined eye tracking calibration data may include a number of eye tracking calibration parameters ETPi, i=1, 2, . . . , M, where each ETPi is an eye tracking calibration parameter. As described in more detail below, in some embodiments, after a user performs an eye tracking calibration, the determined eye tracking calibration data may be stored for future use by the user so that the user need not perform eye tracking calibration each time the user puts on head mounted display device 2.

FIG. 3 shows half of head mounted display device 2. A full head mounted display device 2 would include another set of see-through lenses 116, 118, another opacity filter 114, another light-guide optical element 115, another microdisplay 120, another lens 122, room-facing camera 112, eye position and tracking assembly 134, microdisplay 120, earphones 130, and temperature sensor 138.

FIG. 4 is a block diagram depicting the various components of head mounted display device 2, which is used to provide a mixed reality experience to the user by fusing one or more virtual images seamlessly with the user's view of the real world. Additionally, the components of head mounted display device 2 include many sensors that track various conditions, including the position and rotation of the user's head.

In an embodiment, head mounted display device 2 receives instructions about the virtual image from processing unit 4 and provides the sensor information back to processing unit 4. Processing unit 4 receives the sensory information from head mounted display device 2. Using that information and possibly information from hub computing system 12, processing unit 4 may determine where and when to provide a virtual image to the user and send instructions accordingly to head mounted display device 2.

Some components of FIG. 4 (e.g., room-facing camera 112, eye tracking sensor 134b, microdisplay 120, opacity filter 114, eye tracking illumination device 134a, earphones 130, and temperature sensor 138) are shown in shadow to indicate that there are two of each of those devices, one for the left side and one for the right side of head mounted display device 2. Control circuit 200 communicates with a power management circuit 202. Control circuit 200 includes processor 210, memory controller 212 communicating with memory 214 (e.g., D-RAM), camera interface 216, camera buffer 218, display driver 220, display formatter 222, timing generator 226, display out interface 228, and display in interface 230.

In one embodiment, all components of control circuit 200 communicate with each other via dedicated lines or one or more buses. In another embodiment, each component of control circuit 200 communicates with processor 210. Camera interface 216 provides an interface to room-facing cameras 112 and stores images received from room-facing cameras 112 in camera buffer 218. Display driver 220 will drive microdisplay 120. Display formatter 222 provides information, about the virtual image being displayed on microdisplay 120, to opacity control circuit 224, which controls opacity filter 114. Timing generator 226 is used to provide timing data for the system. Display out interface 228 is a buffer for providing images from room-facing cameras 112 to processing unit 4. Display in interface 230 is a buffer for receiving images such as a virtual image to be displayed on microdisplay 120. Display out interface 228 and display in interface 230 communicate with band interface 232 which is an interface to processing unit 4.

Power management circuit 202 includes voltage regulator 234, eye tracking illumination driver 236, audio DAC and amplifier 238, microphone preamplifier and audio ADC 240, temperature sensor interface 242 and clock generator 244. Voltage regulator 234 receives power from processing unit 4 via band interface 232 and provides that power to the other components of head mounted display device 2. Eye tracking illumination driver 236 provides the IR light source for eye tracking illumination device 134a, as described above. Audio DAC and amplifier 238 output audio information to earphones 130. Microphone preamplifier and audio ADC 240 provides an interface for microphone 110. Temperature sensor interface 242 is an interface for temperature sensor 138. Power management circuit 202 also provides power and receives data back from three axis magnetometer 132a, three axis gyro 132b and three axis accelerometer 132c.

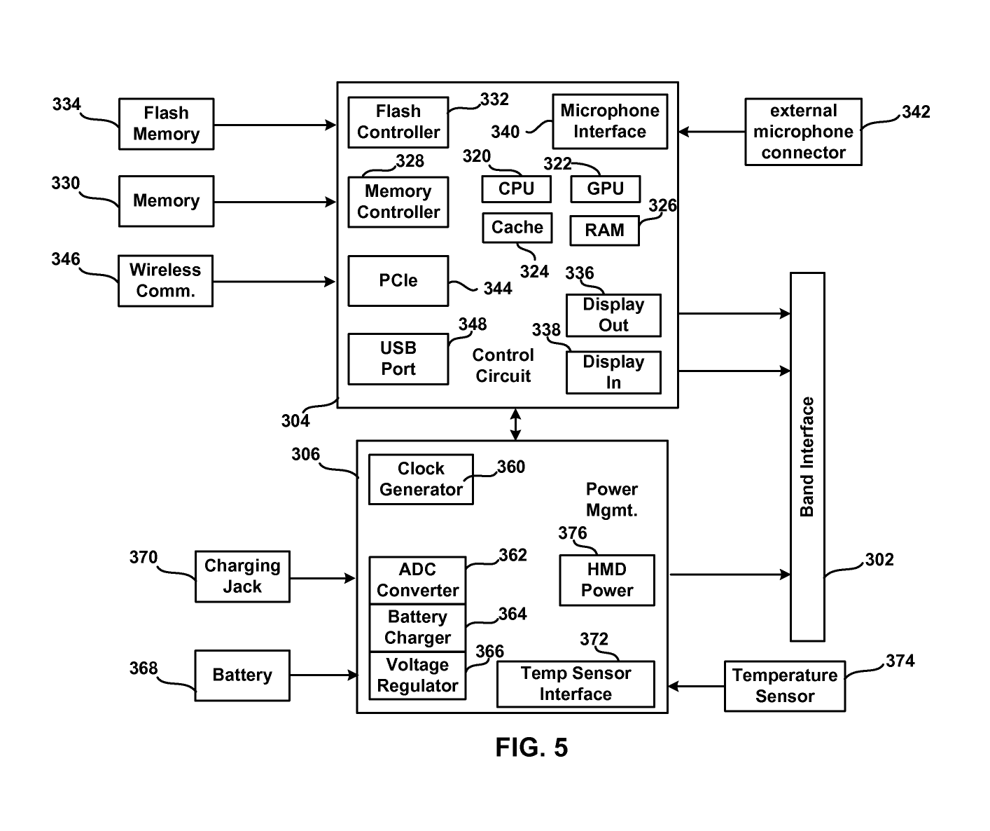

FIG. 5 is a block diagram describing various components of processing unit 4. Control circuit 304 communicates with power management circuit 306, and includes a central processing unit (CPU) 320, graphics processing unit (GPU) 322, cache 324, RAM 326, memory controller 328 communicating with memory 330 (e.g., D-RAM), flash memory controller 332 communicating with flash memory 334 (or other type of non-volatile storage), display out buffer 336 communicating with head mounted display device 2 via band interface 302 and band interface 232, display in buffer 338 communicating with head mounted display device 2 via band interface 302 and band interface 232, microphone interface 340 communicating with an external microphone connector 342 for connecting to a microphone, PCI express interface for connecting to a wireless communication device 346, and USB port(s) 348.

In an embodiment, wireless communication device 346 can include a Wi-Fi enabled communication device, NFC-enabled communication device, BlueTooth communication device, IR communication device, etc. USB port 348 can be used to dock processing unit 4 to hub computing system 12 to load data or software onto processing unit 4, as well as charge processing unit 4. In one embodiment, CPU 320 and GPU 322 are the main workhorses for determining where, when and how to insert virtual three-dimensional objects into the view of the user. More details are provided below.

Power management circuit 306 includes clock generator 360, analog-to-digital (A/D) converter 362, battery charger 364, voltage regulator 366, head mounted display power source 376, and temperature sensor interface 372 communicating with temperature sensor 374 (possibly located on the wrist band of processing unit 4). A/D converter 362 is used to monitor the battery voltage, the temperature sensor and control the battery charging function. Voltage regulator 366 communicates with battery 368 to supply power to the system. Battery charger 364 charges battery 368 (via voltage regulator 366) upon receiving power from charging jack 370. Head mounted display device power source 376 provides power to head mounted display device 2.

The above-described system 10 may be configured to insert a virtual image into the FOV of user 18 so that the virtual image replaces the view of a real world object. Alternatively, the virtual image can be inserted without replacing the image of a real world object. In various embodiments, the virtual image will be adjusted to match the appropriate orientation, size and shape based on the object being replaced or the environment for which the image is being inserted into. In addition, the virtual image can be adjusted to include reflectivity and shadows.

In an embodiment, head mounted display device 2, processing unit 4 and hub computing device 12 work together, as each of the devices includes a subset of sensors that are used to obtain the data for determining where, when and how to insert the virtual images. In one embodiment, calculations that determine where, how and when to insert a virtual image are performed by hub computing device 12. In another embodiment, those calculations are performed by processing unit 4. In another embodiment some of the calculations are performed by hub computing device 12 and other calculations are performed by processing unit 4. In other embodiments, the calculations can be performed by head mounted display device 2.

In an embodiment, hub computing device 12 creates a model of the environment that user 18 is in and tracks various moving objects in that environment. In addition, hub computing device 12 tracks the position and orientation of head mounted display device 2. The model and the tracking information are provided from hub computing device 12 to processing unit 4. Sensor information also may be obtained from head mounted display device 2. Processing unit 4 uses the additional sensor information from head mounted display device 2 to refine the FOV of user 18 and provide instructions to head mounted display device 2 on how, where and when to insert the virtual image.

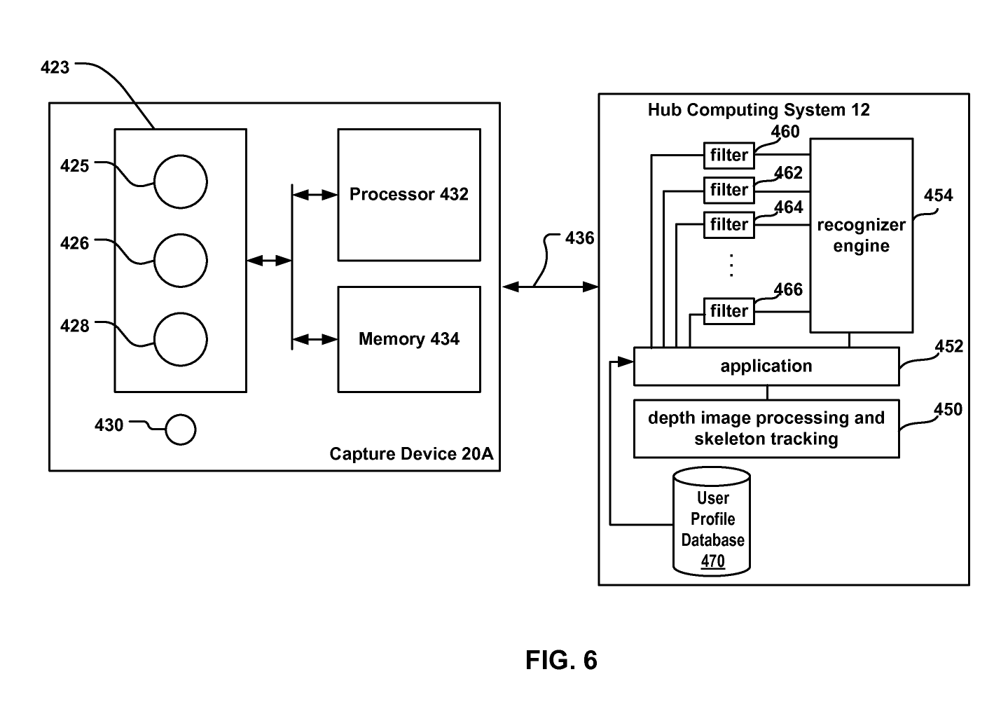

FIG. 6 illustrates an example embodiment of hub computing system 12 with a capture device. In one embodiment, capture devices 20a and 20b are the same structure, therefore, FIG. 6 only shows capture device 20a. According to an example embodiment, capture device 20a may be configured to capture video with depth information including a depth image that may include depth values via any suitable technique including, for example, time-of-flight, structured light, stereo image, or the like. According to an embodiment, capture device 20a may organize the depth information into “Z layers,” or layers that may be perpendicular to a Z axis extending from the depth camera along its line of sight.

As shown in FIG. 6, capture device 20a may include a camera component 423. According to an example embodiment, camera component 423 may be or may include a depth camera that may capture a depth image of a scene. The depth image may include a two-dimensional (2-D) pixel area of the captured scene where each pixel in the 2-D pixel area may represent a depth value such as a distance in, for example, centimeters, millimeters, or the like of an object in the captured scene from the camera.

Camera component 423 may include an IR light component 425, a three-dimensional (3-D) camera 426, and an RGB (visual image) camera 428 that may be used to capture the depth image of a scene. For example, in time-of-flight analysis, IR light component 425 of capture device 20a may emit an IR light onto the scene and may then use sensors (in some embodiments, including sensors not shown) to detect the backscattered light from the surface of one or more targets and objects in the scene using, for example, 3-D camera 426 and/or RGB camera 428.

In some embodiments, pulsed IR light may be used such that the time between an outgoing light pulse and a corresponding incoming light pulse may be measured and used to determine a physical distance from capture device 20a to a particular location on the targets or objects in the scene. Additionally, in other example embodiments, the phase of the outgoing light wave may be compared to the phase of the incoming light wave to determine a phase shift. The phase shift may then be used to determine a physical distance from the capture device to a particular location on the targets or objects.

According to another example embodiment, time-of-flight analysis may be used to indirectly determine a physical distance from capture device 20a to a particular location on the targets or objects by analyzing the intensity of the reflected beam of light over time via various techniques including, for example, shuttered light pulse imaging.

In another example embodiment, capture device 20a may use a structured light to capture depth information. In such an analysis, patterned light (i.e., light displayed as a known pattern such as grid pattern, a stripe pattern, or different pattern) may be projected onto the scene via, for example, IR light component 425. Upon striking the surface of one or more targets or objects in the scene, the pattern may become deformed in response. Such a deformation of the pattern may be captured by, for example, 3-D camera 426 and/or RGB camera 428 (and/or other sensor) and may then be analyzed to determine a physical distance from capture device 20a to a particular location on the targets or objects. In some implementations, the IR light component 425 is displaced from 3-D camera 426 and RGB camera 428 so triangulation can be used to determine distance from 3-D camera 426 and RGB camera 428. In some implementations, capture device 20a includes a dedicated IR sensor to sense IR light, or a sensor with an IR filter.

According to another embodiment, the capture device 20a may include two or more physically separated cameras that may view a scene from different angles to obtain visual stereo data that may be resolved to generate depth information. Other types of depth image sensors can also be used to create a depth image.

Capture device 20a may include a microphone 430, which includes a transducer or sensor that may receive and convert sound into an electrical signal. Microphone 430 may be used to receive audio signals that also may be provided by hub computing system 12.

In an example embodiment, capture device 20a may further include a processor 432 that may communicate with camera component 423. Processor 432 may include a standardized processor, a specialized processor, a microprocessor, or the like that may execute instructions including, for example, instructions for receiving a depth image, generating the appropriate data format (e.g., frame) and transmitting the data to hub computing system 12.

Capture device 20a may further include a memory 434 that may store instructions that are executed by processor 432, images or frames of images captured by the 3-D camera and/or RGB camera, or any other suitable information, images, or the like. According to an example embodiment, memory 434 may include random access memory (RAM), read only memory (ROM), cache, flash memory, a hard disk, or any other suitable storage component. As shown in FIG. 6, in an embodiment, memory 434 may be a separate component communicating with camera component 423 and processor 432. According to another embodiment, memory 434 may be integrated into processor 432 and/or image capture component 422.

Capture devices 20a and 20b communicate with hub computing system 12 via a communication link 436. Communication link 436 may be a wired connection including, for example, a USB connection, a Firewire connection, an Ethernet cable connection, or the like and/or a wireless connection such as a wireless 802.11b, g, a, or n connection. According to one embodiment, hub computing system 12 may provide a clock to capture device 20a that may be used to determine when to capture, for example, a scene via the communication link 436.

Additionally, capture device 20a provides depth information and visual (e.g., RGB) images captured by, for example, the 3-D camera 426 and/or RGB camera 428 to hub computing system 12 via communication link 436. In an embodiment, depth images and visual images are transmitted at 30 frames per second. Other frame rates can be used. Hub computing system 12 may then create and use a model, depth information, and captured images to, for example, control an application such as a game or word processor and/or animate an avatar or on-screen character.

Hub computing system 12 includes depth image processing and skeletal tracking module 450, which uses the depth images to track one or more persons detectable by the depth camera function of capture device 20a. Depth image processing and skeletal tracking module 450 provides the tracking information to application 452, which can be a video game, productivity application, communications application or other software application etc. The audio data and visual image data is also provided to application 452 and depth image processing and skeletal tracking module 450. Application 452 provides the tracking information, audio data and visual image data to recognizer engine 454. In another embodiment, recognizer engine 454 receives the tracking information directly from depth image processing and skeletal tracking module 450 and receives the audio data and visual image data directly from capture devices 20a and 20b.

Recognizer engine 454 is associated with a collection of filters 460, 462, 464, . . . , 466 each comprising information concerning a gesture, action or condition that may be performed by any person or object detectable by capture device 20a or 20b. For example, the data from capture device 20a may be processed by filters 460, 462, 464, . . . , 466 to identify when a user 18 or group of users has performed one or more gestures or other actions. Those gestures may be associated with various controls, objects or conditions of application 452. Thus, hub computing system 12 may use recognizer engine 454, with the filters, to interpret and track movement of objects (including people).

Capture devices 20a and 20b provide RGB images (or visual images in other formats or color spaces) and depth images to hub computing system 12. The depth image may be a plurality of observed pixels where each observed pixel has an observed depth value. For example, the depth image may include a 2-D pixel area of the captured scene where each pixel in the 2-D pixel area may have a depth value such as distance of an object in the captured scene from the capture device. Hub computing system 12 will use the RGB images and depth images to track a user's or object's movements. For example, the system will use the depth images to track a skeleton of a person. There are many methods that can be used to track the skeleton of a person using depth images.

One example of tracking a skeleton using depth images includes acquiring a depth image, down sampling the data, removing and/or smoothing high variance noisy data, identifying and removing the background, and assigning each of the foreground pixels to different parts of the body. Based on those steps, the system will fit a model to the data and create a skeleton. The skeleton will include a set of joints and connections between the joints. Other methods for tracking can also be used. Suitable tracking technologies are also disclosed in the following four U.S. Patent Applications: U.S. patent application Ser. No. 12/475,308, “Device for Identifying and Tracking Multiple Humans Over Time,” filed on May 29, 2009; U.S. patent application Ser. No. 12/696,282, “Visual Based Identity Tracking,” filed on Jan. 29, 2010; U.S. patent application Ser. No. 12/641,788, “Motion Detection Using Depth Images,” filed on Dec. 18, 2009; and U.S. patent application Ser. No. 12/575,388, “Human Tracking System,” filed on Oct. 7, 2009.

Recognizer engine 454 includes multiple filters 460, 462, 464, . . . , 466 to determine a gesture or action. A filter comprises information defining a gesture, action or condition along with parameters, or metadata, for that gesture, action or condition. For instance, a throw, which comprises motion of one of the hands from behind the rear of the body to past the front of the body, may be implemented as a gesture comprising information representing the movement of one of the hands of the user from behind the rear of the body to past the front of the body, as that movement would be captured by the depth camera. Parameters may then be set for that gesture. Where the gesture is a throw, a parameter may be a threshold velocity that the hand has to reach, a distance the hand travels (either absolute, or relative to the size of the user as a whole), and a confidence rating by the recognizer engine that the gesture occurred. These parameters for the gesture may vary between applications, between contexts of a single application, or within one context of one application over time.

Filters may be modular or interchangeable. In one embodiment, a filter has a number of inputs (each of those inputs having a type) and a number of outputs (each of those outputs having a type). A first filter may be replaced with a second filter that has the same number and types of inputs and outputs as the first filter without altering any other aspect of the recognizer engine architecture. For instance, there may be a first filter for driving that takes as input skeletal data and outputs a confidence that the gesture associated with the filter is occurring and an angle of steering. Where one wishes to substitute this first driving filter with a second driving filter—perhaps because the second driving filter is more efficient and requires fewer processing resources—one may do so by simply replacing the first filter with the second filter so long as the second filter has those same inputs and outputs—one input of skeletal data type, and two outputs of confidence type and angle type.

A filter need not have a parameter. For instance, a “user height” filter that returns the user's height may not allow for any parameters that may be tuned. An alternate “user height” filter may have tunable parameters—such as to whether to account for a user's footwear, hairstyle, headwear and posture in determining the user's height.

Inputs to a filter may comprise things such as joint data about a user's joint position, angles formed by the bones that meet at the joint, RGB color data from the scene, and the rate of change of an aspect of the user. Outputs from a filter may comprise things such as the confidence that a given gesture is being made, the speed at which a gesture motion is made, and a time at which a gesture motion is made.

Recognizer engine 454 may have a base recognizer engine that provides functionality to the filters. In one embodiment, the functionality that recognizer engine 454 implements includes an input-over-time archive that tracks recognized gestures and other input, a Hidden Markov Model implementation (where the modeled system is assumed to be a Markov process—one where a present state encapsulates any past state information used to determine a future state, so no other past state information must be maintained for this purpose—with unknown parameters, and hidden parameters are determined from the observable data), as well as other functionality used to solve particular instances of gesture recognition.

Filters 460, 462, 464, . . . , 466 are loaded and implemented on top of recognizer engine 454 and can utilize services provided by recognizer engine 454 to filters 460, 462, 464, . . . , 466. In one embodiment, recognizer engine 454 receives data to determine whether it meets the requirements of any filter 460, 462, 464 , . . . , 466. Because these provided services, such as parsing the input, are provided once by recognizer engine 454 rather than by each filter 460, 462, 464, . . . , 466, such a service need only be processed once in a period of time as opposed to once per filter for that period, so the processing used to determine gestures is reduced.

Application 452 may use filters 460, 462, 464, . . . , 466 provided with recognizer engine 454, or it may provide its own filter, which plugs in to recognizer engine 454. In one embodiment, all filters have a common interface to enable this plug-in characteristic. Further, all filters may utilize parameters, so a single gesture tool below may be used to debug and tune the entire filter system.

More information about recognizer engine 454 can be found in U.S. patent application Ser. No. 12/422,661, “Gesture Recognizer System Architecture,” filed on Apr. 13, 2009. More information about recognizing gestures can be found in U.S. patent application Ser. No. 12/391,150, “Standard Gestures,” filed on Feb. 23, 2009; and U.S. patent application Ser. No. 12/474,655, “Gesture Tool” filed on May 29, 2009.

In one embodiment, hub computing system 12 includes a user profile database 470 that includes user-specific information related to one or more users interacting with hub computing system 12. In one example, the user-specific information includes information related to a user such as the user's expressed preferences, the user's friends' list, the user's preferred activities, a list of the user's reminders, the user's social groups, the user's current location, the user's past intents to interact with objects in the user's environment and other user created content, such as the user's photos, images and recorded videos. In one embodiment, the user-specific information may be obtained from one or more data sources such as the user's social networking sites, address book, email data, Instant Messaging data, user profiles or other sources on the Internet. In one approach, and as will be discussed in detail below, the user-specific information is utilized to automatically determine the user's intent to interact with one or more objects in the user's environment.

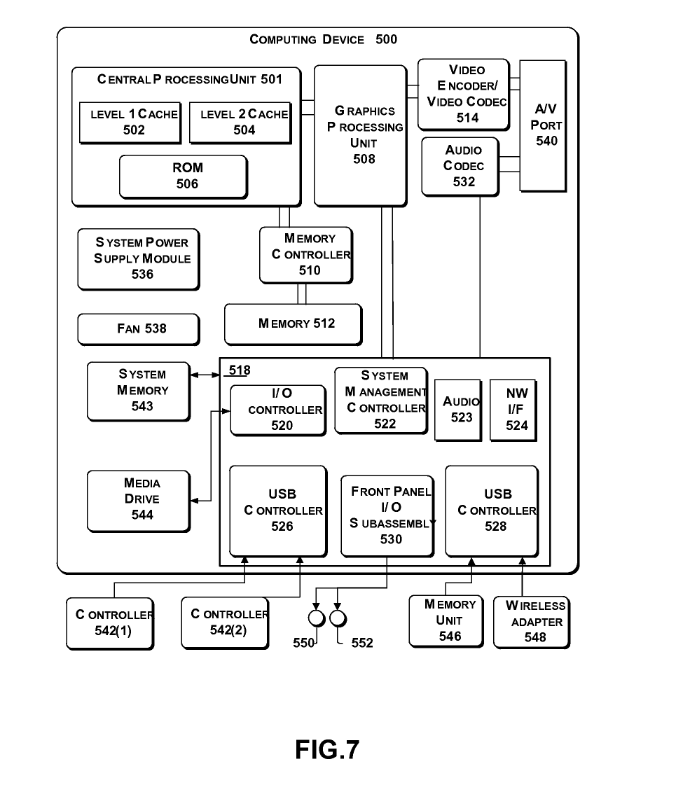

FIG. 7 illustrates an example embodiment of a computing system that may be used to implement hub computing system 12 or other processors disclosed herein. As shown in FIG. 7, computing system 500 has a central processing unit (CPU) 501 having a level 1 cache 502, a level 2 cache 504, and a flash ROM (Read Only Memory) 506. Level 1 cache 502 and level 2 cache 504 temporarily store data and hence reduce the number of memory access cycles, thereby improving processing speed and throughput. CPU 501 may be provided having more than one core, and thus, additional level 1 and level 2 caches 502 and 504, respectively. Flash ROM 506 may store executable code that is loaded during an initial phase of a boot process when computing device 500 is powered ON.

A graphics processing unit (GPU) 508 and a video encoder/video codec (coder/decoder) 514 form a video processing pipeline for high speed and high resolution graphics processing. Data are carried from graphics processing unit 508 to video encoder/video codec 514 via a bus. The video processing pipeline outputs data to an A/V (audio/video) port 540 for transmission to a television or other display. A memory controller 510 is connected to GPU 508 to facilitate processor access to various types of memory 512, such as, but not limited to, a RAM (Random Access Memory).

Computing device 500 includes an I/O controller 520, a system management controller 522, an audio processing unit 523, a network interface 524, a first USB host controller 526, a second USB controller 528 and a front panel I/O subassembly 530 that are preferably implemented on a module 518. USB controllers 526 and 528 serve as hosts for peripheral controllers 542(1)-542(2), a wireless adapter 548, and an external memory device 546 (e.g., flash memory, external CD/DVD ROM drive, removable media, etc.). Network interface 524 and/or wireless adapter 548 provide access to a network (e.g., the Internet, home network, etc.) and may be any of a wide variety of various wired or wireless adapter components including an Ethernet card, a modem, a Bluetooth module, a cable modem, and the like.

System memory 543 is provided to store application data that is loaded during the boot process. A media drive 544 is provided and may comprise a DVD/CD drive, Blu-Ray drive, hard disk drive, or other removable media drive, etc. Media drive 544 may be internal or external to computing device 500. Application data may be accessed via media drive 544 for execution, playback, etc. by computing device 500. Media drive 544 is connected to I/O controller 520 via a bus, such as a Serial ATA bus or other high speed connection (e.g., IEEE 1394).

System management controller 522 provides a variety of service functions related to assuring availability of computing device 500. Audio processing unit 523 and an audio codec 532 form a corresponding audio processing pipeline with high fidelity and stereo processing. Audio data is carried between audio processing unit 523 and audio codec 532 via a communication link. The audio processing pipeline outputs data to A/V port 540 for reproduction by an external audio user or device having audio capabilities.

Front panel I/O subassembly 530 supports the functionality of a power button 550 and an eject button 552, as well as any LEDs (light emitting diodes) or other indicators exposed on the outer surface of computing device 500. A system power supply module 536 provides power to the components of computing device 500. A fan 538 cools the circuitry within computing device 500.

CPU 501, GPU 508, memory controller 510, and various other components within computing device 500 are interconnected via one or more buses, including serial and parallel buses, a memory bus, a peripheral bus, and a processor or local bus using any of a variety of bus architectures. By way of example, such architectures can include a Peripheral Component Interconnects (PCI) bus, PCI-Express bus, etc.

When computing device 500 is powered ON, application data may be loaded from system memory 543 into memory 512 and/or caches 502, 504 and executed on CPU 501. The application may present a graphical user interface that provides a consistent user experience when navigating to different media types available on computing device 500. In operation, applications and/or other media contained within media drive 544 may be launched or played from the media drive 544 to provide additional functionalities to computing device 500.

Computing device 500 may be operated as a standalone system by simply connecting the system to a television or other display. In this standalone mode, computing device 500 allows one or more users to interact with the system, watch movies, or listen to music. However, with the integration of broadband connectivity made available through network interface 524 or wireless adapter 548, computing device 500 may further be operated as a participant in a larger network community. Additionally, computing device 500 can communicate with processing unit 4 via wireless adaptor 548.

When computing device 500 is powered ON, a set amount of hardware resources are reserved for system use by the multimedia console operating system. These resources may include a reservation of memory, CPU and GPU cycle, networking bandwidth, etc. Because these resources are reserved at system boot time, the reserved resources do not exist from the application's view. In particular, the memory reservation preferably is large enough to contain the launch kernel, concurrent system applications and drivers. The CPU reservation is preferably constant such that if the reserved CPU usage is not used by the system applications, an idle thread will consume any unused cycles.

With regard to the GPU reservation, lightweight messages generated by the system applications (e.g., pop ups) are displayed by using a GPU interrupt to schedule code to render popup into an overlay. The amount of memory required for an overlay depends on the overlay area size and the overlay preferably scales with screen resolution. Where a full user interface is used by the concurrent system application, it is preferable to use a resolution independent of application resolution. A scaler may be used to set this resolution such that the need to change frequency and cause a TV resync is eliminated.

After computing device 500 boots and system resources are reserved, concurrent system applications execute to provide system functionalities. The system functionalities are encapsulated in a set of system applications that execute within the reserved system resources described above. The operating system kernel identifies threads that are system application threads versus gaming application threads. The system applications are preferably scheduled to run on the CPU 501 at predetermined times and intervals in order to provide a consistent system resource view to the application. The scheduling is to minimize cache disruption for the gaming application running on the console.

When a concurrent system application requires audio, audio processing is scheduled asynchronously to the gaming application due to time sensitivity. A multimedia console application manager (described below) controls the gaming application audio level (e.g., mute, attenuate) when system applications are active.

Optional input devices (e.g., controllers 542(1) and 542(2)) are shared by gaming applications and system applications. The input devices are not reserved resources, but are to be switched between system applications and the gaming application such that each will have a focus of the device. The application manager preferably controls the switching of input stream, without knowing the gaming application's knowledge and a driver maintains state information regarding focus switches. Capture devices 20a and 20b may define additional input devices for the device 500 via USB controller 526 or other interface. In other embodiments, hub computing system 12 can be implemented using other hardware architectures. No one hardware architecture is required.

As described above, to accurately track a user's eye gaze, a user of head mounted display device 2 typically performs an eye tracking calibration to map detected gaze positions to corresponding positions on light-guide optical elements 115. An eye tracking calibration process may require a user to “look at” a large number of transmitted images, and hence may be quite time consuming.

Because eye tracking calibration data are user-specific, if multiple users want to use a head mounted display device 2, the head mounted display device 2 must be recalibrated each time the head mounted display device 2 is passed from user to user. This scenario may be quite common, for example, when multiple users in a family, group of friends, co-workers or other group share a head mounted display device 2. Such eye tracking recalibration can thus become tedious and burdensome, and may inhibit multiple users from using head mounted display device 2.

In an embodiment, head mounted display device 2 is automatically calibrated for a user by automatically identifying the user, and retrieving previously determined eye tracking calibration data for the identified user. In an embodiment, the user may be automatically identified based on measurements of the user's IPD value.

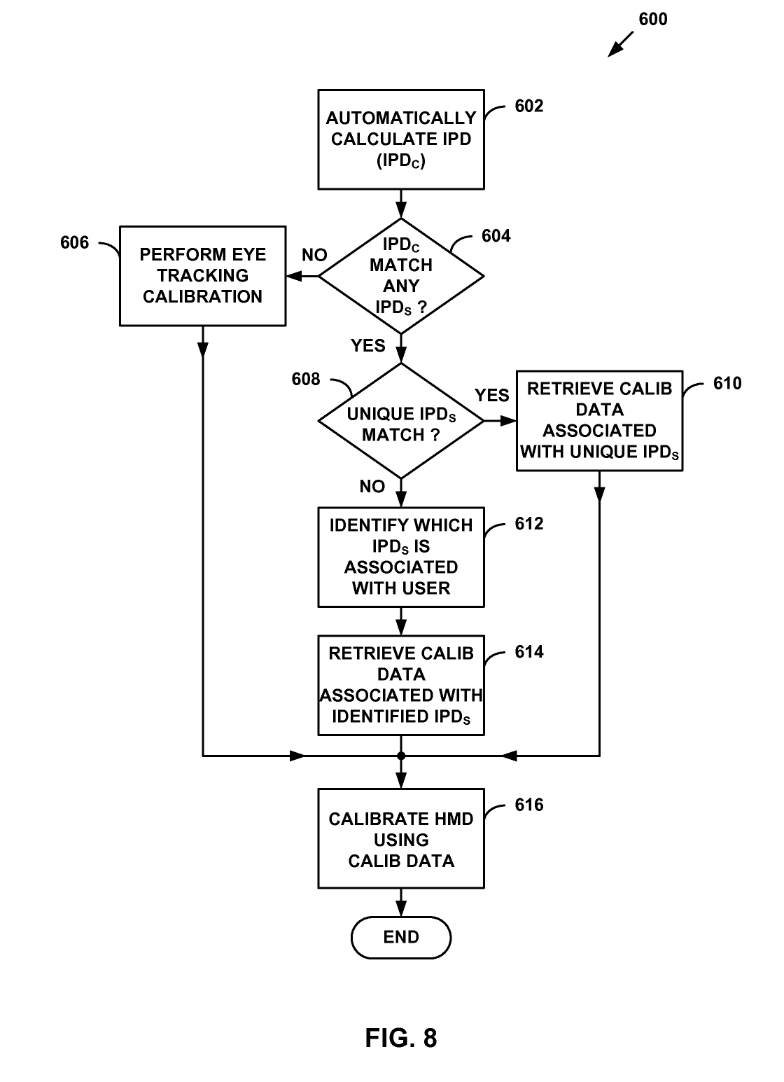

FIG. 8 is a simplified flow chart depicting an automatic eye tracking calibration process 600 according to an embodiment of the present technology. Other steps could be added and many variations are possible. Not all steps are required. In an embodiment, process 600 may be performed by one or more components of head mounted device 2 as depicted in FIG. 1.

Various steps of process 600 may be performed by software, hardware, or a combination of hardware and software. Herein, the term “logic” refers to software, hardware, or a combination of hardware and software. Thus, head mounted display device 2 may have logic that is configured to perform process 600. In some embodiments, the logic that performs some or all of the operations may be at hub computing system 12, or some other processor. The steps illustrated in FIG. 8 may be performed in parallel or simultaneously, and steps may be performed continuously.

Automatic eye tracking calibration process 600 begins after a user puts on head mounted display device 2. In step 602, the user's IPD value is automatically calculated. For example, as described above, in an embodiment, head mounted display device 2 includes separate eye position and tracking assemblies 134 for each of the left and right eyes. In an embodiment, after a user puts on head mounted display device 2, eye position and tracking assemblies 134 automatically determine the center of each eye, and processor 210 automatically calculates the user's IPD value (referred to herein as “IPDc value”).

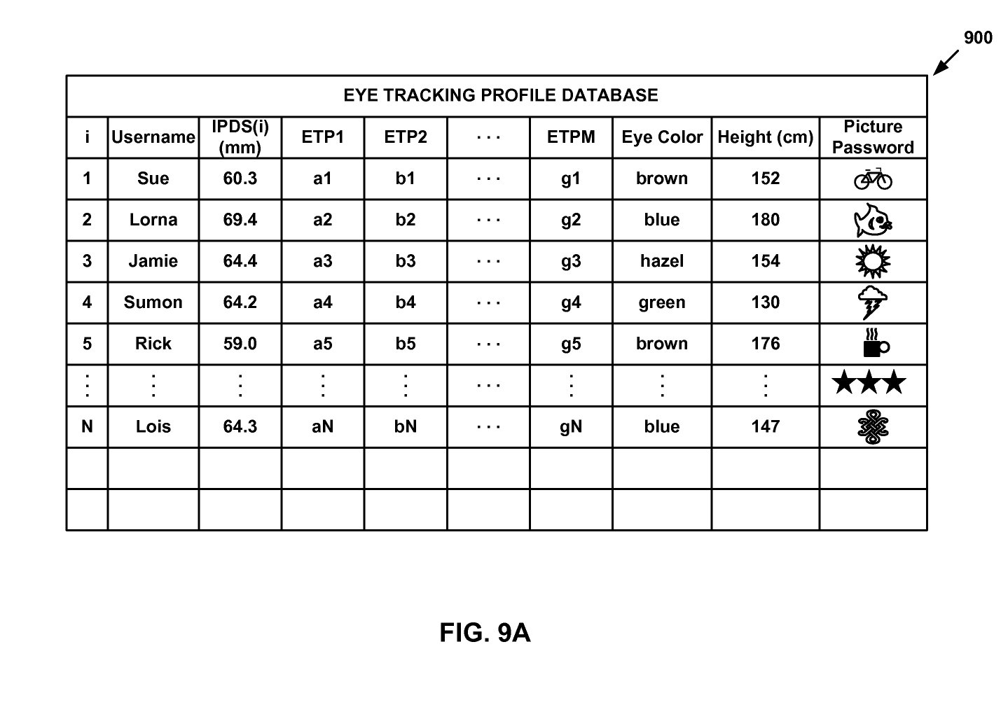

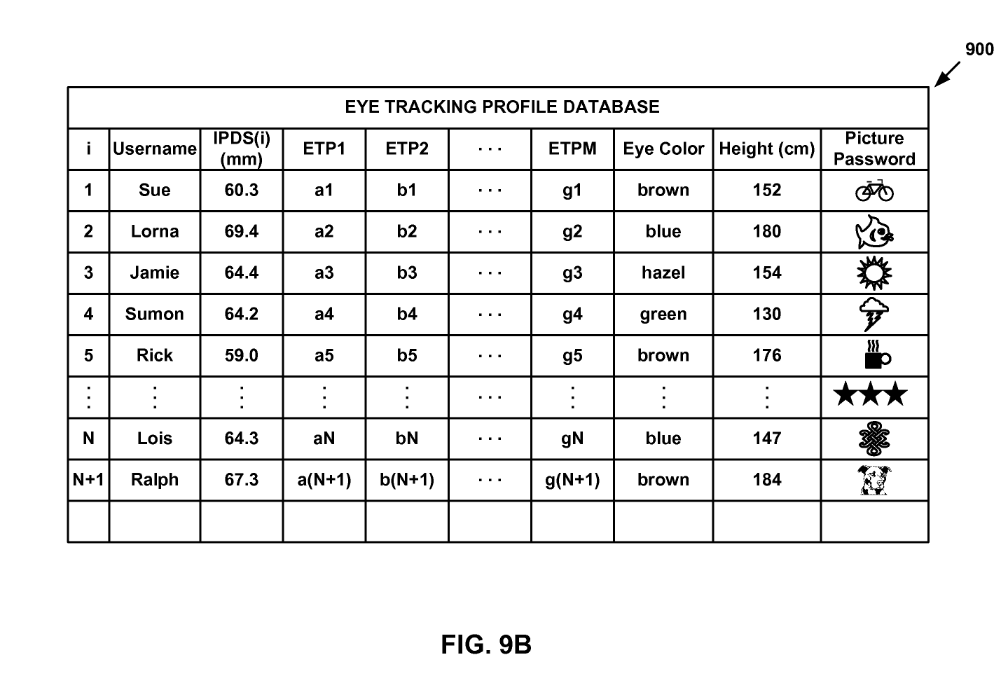

In step 604, a determination is made whether the automatically calculated IPDc value matches (within a predetermined tolerance) one or more previously determined IPD values (referred to herein as “previously determined IPDs values”). In an embodiment, previously determined IPDs values may be stored in memory, such as memory 214, or some other memory. In an embodiment, previously determined IPDs values may be stored in an eye tracking profile database. FIG. 9A illustrates an example eye tracking profile database 900.

In an embodiment, eye tracking profile database 900 includes multiple rows of data, with each row including an eye tracking profile for a particular user of head mounted display device 2. Eye tracking profile database 900 also includes multiple columns of data, with each column including eye tracking profile data for the users in rows 1, 2, . . . , N. For example, the first column includes a username for each user, the second column includes previously determined IPDs values for each user, and the next M columns include eye tracking calibration parameters for each user.

In some embodiments, additional biometric data associated with each user also may be stored in eye tracking calibration database 900. For example, eye tracking profile database 900 includes a column specifying an eye color associated with each user, and a column specifying a height of each user. In addition, in some embodiments, user-identifiable passwords also may be stored in eye tracking calibration database 900. For example, eye tracking profile database 900 includes a column that includes visual passwords in the form of images associated with each user. Eye tracking profile 900 may be stored in user profile database 470 of hub computing system 12, or may be stored in other memory of head mounted display device 2.

In example eye tracking profile database 900, Sue has a previously determined IPDs value of 60.3 mm and associated eye tracking calibration data ETP1=a1, ETP2=b1, . . . , and ETPM=g1, an eye color “brown,” a height of 152 cm, and a visual password of a bicycle. In contrast, Sumon has a previously determined IPDs value of 64.2 mm and associated tracking calibration data ETP1=a4, ETP2=b4, . . . , and ETPM=g4, an eye color “green,” a height of 130 cm, and a visual password of a cloud and thunderbolt. Persons of ordinary skill in the art will understand that eye tracking profile database 900 may include more, fewer or different columns than those depicted in FIG. 9A.

Referring again to FIG. 8, in an embodiment, to determine if the automatically calculated IPDc value of step 602 matches one or more previously determined IPDs values, processor 210 calculates:

Δi=|IPDc−IPDs(i)|, i=1,2, . . . , N

using IPDs(i) values from eye tracking profile database 900. In addition, processor 210 determines that an automatically calculated IPDc value matches a previously determined IPDs value if:

Δi≦Δmax

where Δmax is a predetermined tolerance for specifying a matching IPD value. In some embodiments, Δmax may be between about 0.05 mm to about 0.15 mm, although other values may be used.

For example, if an automatically calculated IPDc value for a user is 64.3 mm, and the predetermined tolerance Δmax=0.1 mm, using eye tracking profile database 900 of FIG. 9A, processor 210 determines that the automatically calculated IPDc value matches the previously determined IPDs(3), IPDs(4) and IPDs(N) values for Jamie, Sumon and Lois, respectively, within the predetermined tolerance. Persons of ordinary skill in the art will understand that an automatically calculated IPDc value may not match any previously determined IPDs value, or may match one, two or more previously determined IPDs values, based on the Δmax value.

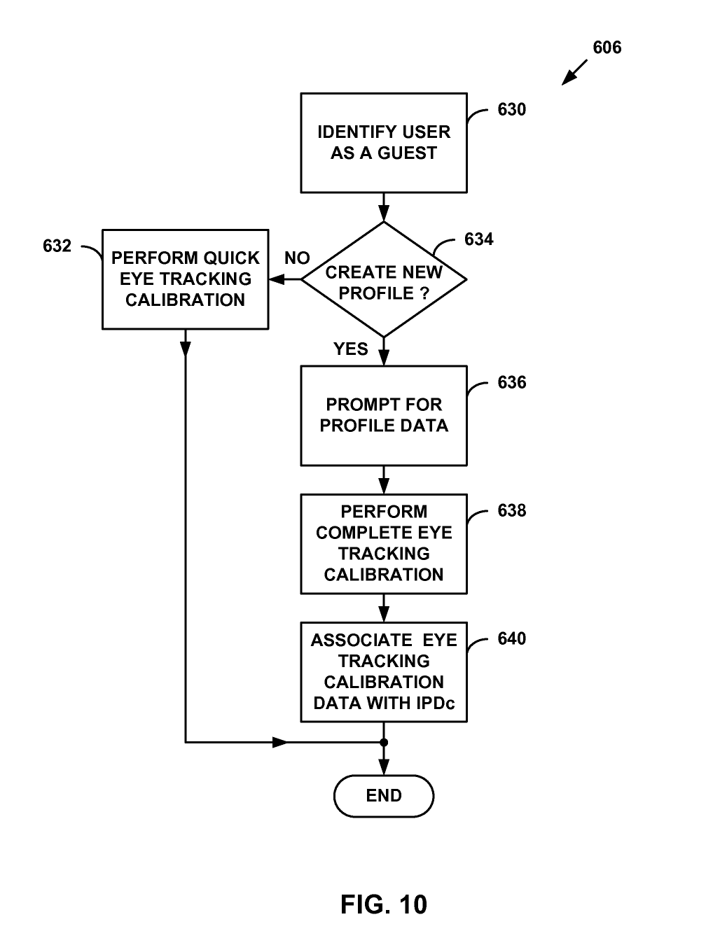

Referring again to FIG. 8, if the determination at step 604 is that the automatically calculated IPDc value does not match any previously determined IPDs value, the process proceeds to step 606 to perform an eye tracking calibration process for the user. FIG. 10 illustrates an example eye tracking calibration process 606. At step 630, the user is identified as a guest (new) user. At step 632, the user is prompted to create an eye tracking profile. For example, as described above, computing system 500 may include a graphical user interface, which may be used to ask if the user would like to create an eye tracking profile.

If the user decides not to create an eye tracking profile, at step 632, the user may continue to use head mounted display device 2 as a guest, and a “quick” eye tracking calibration may be performed to create temporary eye tracking calibration data for the user. For example, in an embodiment, eye position and tracking assembly 134 (FIG. 3) may perform an abbreviated eye tracking calibration process by requiring the user to “look at” a reduced number of transmitted images (e.g., fewer than would be used for a complete eye tracking calibration). In an another embodiment, the system may use previously stored eye tracking calibration data from another user having a similar IPD. The quick eye tracking calibration may not be as accurate or robust as a complete eye tracking calibration, but may be sufficient to permit the user to use head mounted display device 2 as a guest. After performing the quick calibration, process 606 ends. Referring again to FIG. 8, process 600 proceeds to step 616, and head mounted display device 2 is automatically calibrated for the user using the temporary eye tracking calibration data determined at step 632 of process 606.

Referring again to FIG. 10, if at step 634 the user decides to create an eye tracking profile, at step 636 the graphical user interface of computing system 500 prompts the user to provide user-profile information, such as a username, visual password, or other information. As described above, eye tracking profiles may be stored in user profile database 470 of hub computing system 12, or other memory of head mounted display device 2.

At step 638, a complete eye tracking calibration is performed to determine eye tracking calibration data for the user. For example, as described above, eye position and tracking assembly 134 (FIG. 3) performs an eye tracking calibration process to map a user's detected gaze positions to corresponding positions on light-guide optical elements 115. As described above, the eye tracking calibration data for a user may include a number of parameters ETPi, i=1, 2, . . . , M, where ETPi is an eye tracking calibration data parameter.

At step 640, the eye tracking calibration data generated in step 638 are associated with the automatically calculated IPDc value determined in step 602 (FIG. 8). In an embodiment, the automatically calculated IPDc value for a user and the eye tracking calibration data for the user are stored as a new entry in eye tracking profile database 900. FIG. 9B illustrates eye tracking profile database 900 updated to include the eye tracking profile for new user Ralph.

In this example, eye tracking profile database 900 is updated to show that Ralph has a previously determined IPDs value of 67.3 mm (using the automatically calculated IPDc value determined in step 602), and has associated eye tracking calibration data ETP1=a(N+1), ETP2=b(N+1), . . . , ETPMg(N+1). In addition, eye tracking profile database 900 is updated to include other biometric data, if available.

For example, as described above, eye tracking sensor 134b may determine a user's eye color, and capture devices 20a and 20b and recognizer engine 454 may determine a user's height. In FIG. 9B, eye tracking profile database 900 is updated using this information to include Ralph's eye color (brown) and height (184 cm), and the user-specified visual password (a dog in this example).

Referring again to FIG. 10 after step 640, process 600 ends. Referring again to FIG. 8, process 600 proceeds to step 616, and head mounted display device 2 is automatically calibrated using the eye tracking calibration data determined at step 638 of process 606.

If the determination at step 604 is that the automatically calculated IPDc value matches one or more previously determined IPDs value, the process proceeds to step 608 to determine if the automatically calculated IPDc value uniquely matches one previously determined IPDs value. If the determination at step 608 is that the automatically calculated IPDc value uniquely matches one previously determined IPDs value, the process proceeds to step 610, and the eye tracking calibration data associated with the unique IPDs value are retrieved from eye tracking profile 900.

For example, if the automatically calculated IPDc value for a user matches the second entry (i=2) in eye tracking profile 900, the associated eye tracking calibration data ETP1=a2, ETP2=b2, . . . , ETPM=g2 are retrieved from eye tracking profile 900. Process 600 proceeds to step 616, and head mounted display device 2 is automatically calibrated using the eye tracking calibration data retrieved from eye tracking profile 900 at step 610.

If the determination at step 608 is that the automatically calculated IPDc value does not uniquely match one previously determined IPDs value, the process proceeds to step 612 to determine which of the multiple matching previously determined IPDs values is associated with the user.

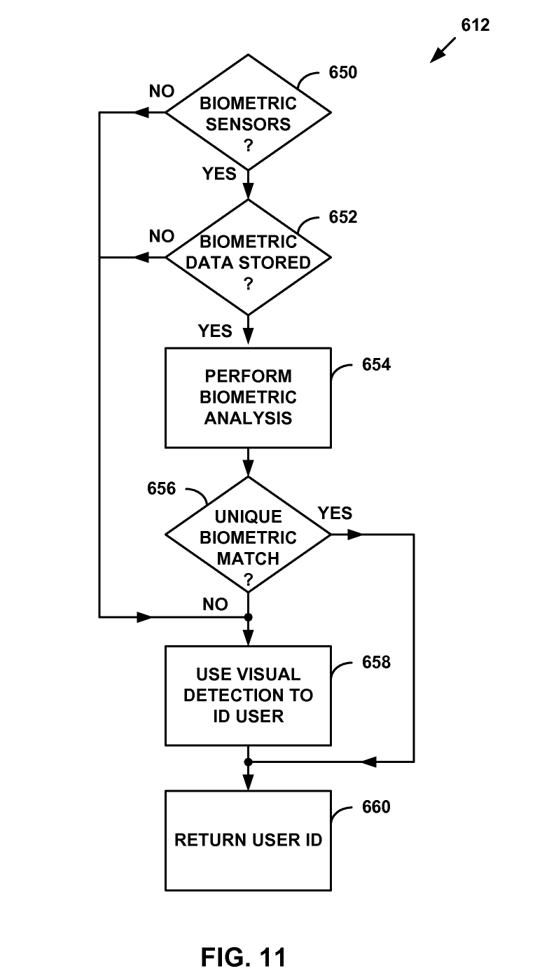

FIG. 11 is a block diagram of an example process 612 to determine which of the multiple matching previously determined IPDs values is associated with the user. At step 650, a determination is made whether head mounted display device 2 and/or hub computing system 12 include biometric sensors that may be used to detect biometric data to identify the user. That is, because the automatically calculated IPDc value matches multiple previously stored IPDs values in eye tracking profile 900, the system first attempts to use other biometric data associated with the user to determine which of the multiple matching entries is associated with the user.

For example, as described above with respect to FIG. 4, in some embodiments, head mounted display device 2 includes eye tracking sensor 134b, which captures an image of the eye and includes image sensors to detect the color of the eye. Also, as described above with respect to FIG. 6, in some embodiments, hub computing system 12 includes capture devices 20a and 20b, recognizer engine 454 and collection filters 460, 462, 464, . . . , 466, which capture visual image data of a user, and determine a user's height based on the captured visual image data. Persons of ordinary skill in the art will understand that head mounted display device 2 and/or hub computing system 12 may include other biometric sensors that may be used to detect other biometric data about the user.

If head mounted display device 2 and/or hub computing system 12 include biometric sensors, at step 652 a determination is made whether eye tracking profile 900 includes previously stored biometric data. As described above, in some embodiments, eye tracking profile 900 includes biometric data, such as eye color, height, etc. If eye tracking profile 900 includes biometric data, at step 654 one or more of the biometric sensors are used to determine biometric data for the user. For example, eye tracking sensor 134b may detect the color of the user's eye and/or capture devices 20a and 20b, recognizer engine 454 and collection filters 460, 462, 464, . . . , 466 may determine the user's height. Other biometric sensors also may be used to collect other biometric data about the user.

At step 656, a determination is made whether the biometric data determined at step 654 uniquely matches biometric data for one of the multiple matching previously determined IPDs values in eye tracking profile 900. For example, if an automatically calculated IPDc value for a user is 64.3 mm, and the predetermined tolerance Δmax=0.1 mm, using eye tracking profile database 900 of FIG. 9A, processor 210 determines that the automatically calculated IPDc value matches the previously determined IPDs(3), IPDs(4) and IPD(N) values for Jamie, Sumon and Lois, respectively, within the predetermined tolerance.

If biometric sensors determine that the user has an eye color of “green,” and/or has a height of about 130 cm (within a predetermined tolerance), processor 210 determines that the user's automatically calculated IPDc value is a unique match to Sumon's previously determined IPDs value. In contrast, if biometric sensors determine that the user has an eye color of “hazel,” and/or has a height of about 154 cm (within a predetermined tolerance), processor 210 determines that the user's automatically calculated IPDc value is a unique match to Jamie's previously determined IPDs value. Alternatively, if biometric sensors determine that the user has an eye color of “blue,” and/or has a height of about 147 cm (within a predetermined tolerance), processor 210 determines that the user's automatically calculated IPDc value is a unique match to Lois' previously determined IPDs value. Referring again to FIG. 11, process 612 proceeds to step 660, and the identified user information is returned. Referring again to FIG. 8, at step 614 the calibration data associated with the identified user is extracted from eye tracking profile 900, and at step 616 head mounted display device 2 is automatically calibrated using the eye tracking calibration data determined at step 614 of process 600.

Referring again to FIG. 11, if at step 656 a determination is made that the biometric data determined at step 654 does not uniquely match biometric data for one of the multiple matching previously stored IPDs values in eye tracking profile 900, or if at step 650 a determination is made that head mounted display device 2 and/or hub computing system 12 do not include biometric sensors that may be used to detect biometric data to identify the user, or if at step 652 a determination is made that eye tracking profile 900 does not include previously stored biometric data, at step 658, a visual detection process is used to identify the user whose automatically calculated IPDc value matches multiple previously determined IPDs values.

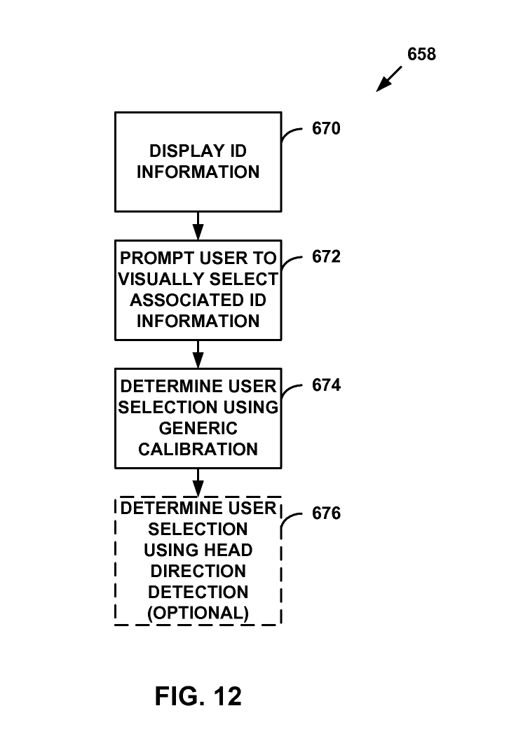

FIG. 12 illustrates an example visual detection process 658 to identify the user whose automatically calculated IPDc value matches multiple previously determined IPDs values. At step 670, identifying information associated with the multiple matching previously determined IPDs values is displayed for the user. For example, in an embodiment, light-guide optical elements 115 may transmit the associated identifying information to the eyes of a user wearing head mounted display device 2. In an embodiment, the displayed associated identifying information may be text (e.g., usernames or other text) associated with each of the multiple matching previously determined IPDs values. In another embodiment, the displayed associated identifying information may be the visual password associated with each of the multiple matching previously determined IPDs values.

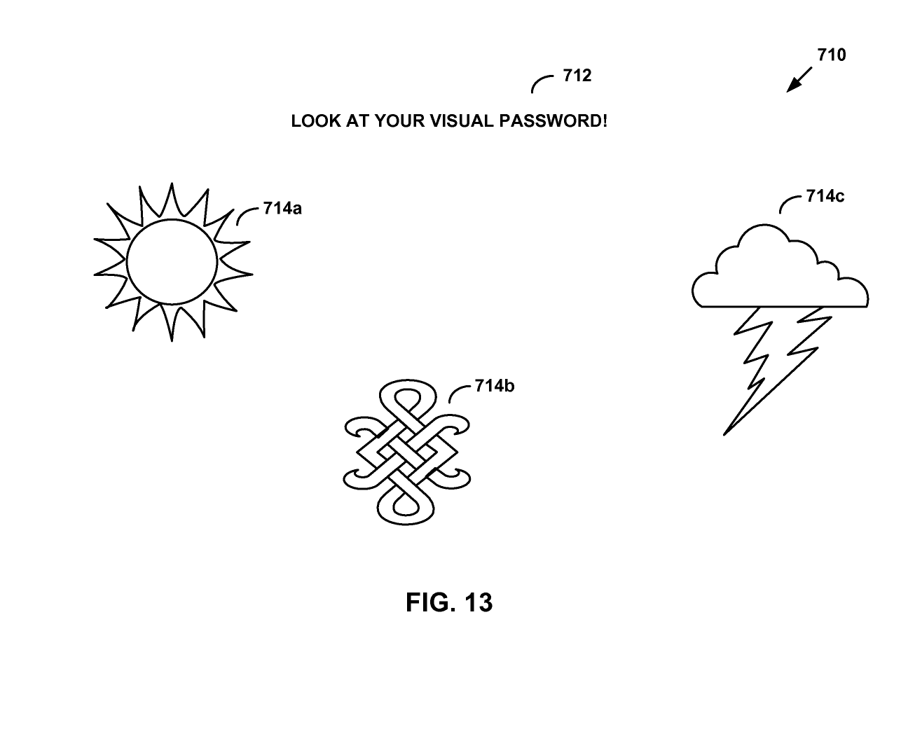

For example, if the automatically calculated IPDc value matches the previously stored IPDs(3), IPDs(4) and IPDs(N) values for Jamie, Sumon and Lois, respectively, within the predetermined tolerance, FIG. 13 illustrates an example display 710 of visual passwords associated with each of the matching previously determined IPDs values. In particular, display 710 includes a command statement 712 instructing the user to look at their visual password, and includes images 714a, 714b and 714c of the visual passwords associated with the matching previously determined IPDs(3), IPDs(4) and IPDs(N) values, respectively. Persons of ordinary skill in the art will understand that display 710 may include a different command statement 712, and may include additional or different information displayed to the user.

Referring again to FIG. 12, at step 672 the user is prompted to visually select their associated identifying information. For example, as described above, display 710 may instruct the user to look at their visual password. In addition, or alternatively, audio instructions may be provided to the user via earphones 130. The audio instructions may direct the user to look at their visual password.

At step 674, eye position and tracking assembly 134 determines the user's view direction to determine the user's selection of one of the displayed visual passwords. For example, as described above, eye position and tracking assembly 134 may determine the user's view direction by detecting head orientation and/or eye gaze. For purposes of this determination, eye position and tracking assembly 134 may use generic eye tracking calibration data, which may be sufficient to determine the user's gaze in this context.

At step 676, optionally, or alternatively, the user may be instructed to make a particular gesture (e.g., waving hand) to indicate their selection of their visual password, and capture devices 20a and 20b may visually monitor the user to detect the specified gesture. The user's selection of their visual password is used with eye tracking profile 900 to identify the user.

Referring again to FIG. 11, process 612 proceeds to step 660, and the identified user information is returned. Referring again to FIG. 8, at step 614 the calibration data associated with the identified user is extracted from eye tracking profile 900, and at step 616 head mounted display device 2 is automatically calibrated using the eye tracking calibration data determined at step 614.

### ASPECTS OF CERTAIN EMBODIMENTS

One or more embodiments include a method of automatically calibrating a head mounted display device for a user, the method comprising automatically calculating an inter-pupillary distance value for the user, comparing the automatically calculated inter-pupillary distance value to a previously determined inter-pupillary distance value, determining if the automatically calculated inter-pupillary distance value matches the preexisting inter-pupillary distance value, and automatically calibrating the head mounted display device using calibration data associated with matching previously determined inter-pupillary distance value.

In a method embodiment, determining includes determining if the automatically calculated inter-pupillary distance value is within a predetermined tolerance of the previously determined inter-pupillary distance value.

In a method embodiment, the previously determined inter-pupillary distance value includes a first previously determined inter-pupillary distance value associated with a first user and a second previously determined inter-pupillary distance value associated with a second user. Comparing includes comparing the automatically calculated inter-pupillary distance value to the first previously determined inter-pupillary distance value and the second previously determined inter-pupillary distance value.

In a method embodiment, determining includes determining if the automatically calculated inter-pupillary distance value uniquely matches one of the first previously determined inter-pupillary distance value and the second previously determined inter-pupillary distance value.

In a method embodiment, if the automatically calculated inter-pupillary distance value uniquely matches one of the first previously determined inter-pupillary distance value and the second previously determined inter-pupillary distance value, automatically calibrating includes calibrating the head mounted display device using calibration data associated with the uniquely matching previously determined inter-pupillary distance value.

In a method embodiment, if the automatically calculated inter-pupillary distance value matches both the first previously determined inter-pupillary distance value and the second previously determined inter-pupillary distance value, the method further includes determining which of the first previously determined inter-pupillary distance value and the second previously determined inter-pupillary distance value is associated with the user, and automatically calibrating includes calibrating the head mounted display device using calibration data associated with the previously determined inter-pupillary distance value associated with the user.

In a method embodiment, determining which of the first previously determined inter-pupillary distance value and the second previously determined inter-pupillary distance value is associated with the user includes displaying information to the user, wherein the displayed information comprises first information uniquely associated with the first user and second information uniquely associated with the second user, determining a view direction of the user, and detecting a selection of one of the first information and the second information by the user.

In a method embodiment, determining the view direction of the user includes determining one or more of a head position of the user and an eye gaze of the user.

In a method embodiment, the displayed information includes one or more of text and an image.

One or more embodiments include a head mounted display device that includes an eye position and tracking assembly and a processor. The eye position and tracking assembly is configured to automatically calculate an inter-pupillary distance value for the user. The processor is configured to compare the automatically calculated inter-pupillary distance value to a previously determined inter-pupillary distance value, determine if the automatically calculated inter-pupillary distance value matches, within a predetermined tolerance, the preexisting inter-pupillary distance value, and automatically calibrate the head mounted display device using calibration data associated with matching previously determined inter-pupillary distance value.

In a device embodiment, the previously determined inter-pupillary distance value includes a first previously determined inter-pupillary distance value associated with a first user and a second previously determined inter-pupillary distance value associated with a second user. The processor is configured to compare the automatically calculated inter-pupillary distance value to the first previously determined inter-pupillary distance value and the second previously determined inter-pupillary distance value.

In a device embodiment, the processor is configured to determine if the automatically calculated inter-pupillary distance value uniquely matches one of the first previously determined inter-pupillary distance value and the second previously determined inter-pupillary distance value.

In a device embodiment, if the automatically calculated inter-pupillary distance value uniquely matches one of the first previously determined inter-pupillary distance value and the second previously determined inter-pupillary distance value, the processor is configured to calibrate the head mounted display device using calibration data associated with the uniquely matching previously determined inter-pupillary distance value.

In a device embodiment, if the automatically calculated inter-pupillary distance value matches both the first previously determined inter-pupillary distance value and the second previously determined inter-pupillary distance value, the processor is further configured to determine which of the first previously determined inter-pupillary distance value and the second previously determined inter-pupillary distance value is associated with the user, and calibrate the head mounted display device using calibration data associated with the previously determined inter-pupillary distance value associated with the user.

In a device embodiment, the processor is further configured to display information to the user, wherein the displayed information comprises first information uniquely associated with the first user and second information uniquely associated with the second user, determine a view direction of the user, and detect a selection of one of the first information and the second information by the user.

One or more embodiments include an apparatus that includes a computer system and a head-mounted display device. The computer system provides an electronic signal representing image data. and the head-mounted display device provides image data in response to the electronic signal. The head-mounted display device includes an eye position and tracking assembly and a processor. The eye position and tracking assembly is configured to automatically calculate an inter-pupillary distance value for the user. The processor is configured to compare the automatically calculated inter-pupillary distance value to a previously determined inter-pupillary distance value, determine if the automatically calculated inter-pupillary distance value matches, within a predetermined tolerance, the preexisting inter-pupillary distance value, and automatically calibrate the head mounted display device using calibration data associated with matching previously determined inter-pupillary distance value.

In an apparatus embodiment, the previously determined inter-pupillary distance value includes a first previously determined inter-pupillary distance value associated with a first user and a second previously determined inter-pupillary distance value associated with a second user. The processor is configured to compare the automatically calculated inter-pupillary distance value to the first previously determined inter-pupillary distance value and the second previously determined inter-pupillary distance value.

In an apparatus embodiment, the processor is configured to determine if the automatically calculated inter-pupillary distance value uniquely matches one of the first previously determined inter-pupillary distance value and the second previously determined inter-pupillary distance value.

In an apparatus embodiment, if the automatically calculated inter-pupillary distance value uniquely matches one of the first previously determined inter-pupillary distance value and the second previously determined inter-pupillary distance value, the processor is configured to calibrate the head mounted display device using calibration data associated with the uniquely matching previously determined inter-pupillary distance value.

In an apparatus embodiment, if the automatically calculated inter-pupillary distance value matches both the first previously determined inter-pupillary distance value and the second previously determined inter-pupillary distance value, the processor is further configured to determine which of the first previously determined inter-pupillary distance value and the second previously determined inter-pupillary distance value is associated with the user, and calibrate the head mounted display device using calibration data associated with the previously determined inter-pupillary distance value associated with the user.

One or more embodiments include a head mounted display device means (2) that includes an eye position and tracking means (134) and a processor means (210). The eye position and tracking means is configured to automatically calculate an inter-pupillary distance value for the user. The processor means is configured to compare the automatically calculated inter-pupillary distance value to a previously determined inter-pupillary distance value, determine if the automatically calculated inter-pupillary distance value matches, within a predetermined tolerance, the preexisting inter-pupillary distance value, and automatically calibrate the head mounted display device means using calibration data associated with matching previously determined inter-pupillary distance value.

Embodiments described in the previous paragraphs may also be combined with one or more of the specifically disclosed alternatives.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims. It is intended that the scope of the invention be defined by the claims appended hereto.

1. A method of automatically calibrating a head mounted display device for a user, the method comprising:
automatically calculating an inter-pupillary distance value for the user;
comparing the automatically calculated inter-pupillary distance value to a previously determined inter-pupillary distance value;
determining if the automatically calculated inter-pupillary distance value matches the preexisting inter-pupillary distance value; and
automatically calibrating the head mounted display device using calibration data associated with matching previously determined inter-pupillary distance value.

2. The method of claim 1, wherein determining comprises determining if the automatically calculated inter-pupillary distance value is within a predetermined tolerance of the previously determined inter-pupillary distance value.

3. The method of claim 1, wherein:
the previously determined inter-pupillary distance value comprises a first previously determined inter-pupillary distance value associated with a first user and a second previously determined inter-pupillary distance value associated with a second user; and
comparing comprises comparing the automatically calculated inter-pupillary distance value to the first previously determined inter-pupillary distance value and the second previously determined inter-pupillary distance value.

4. The method of claim 3, wherein determining comprises determining if the automatically calculated inter-pupillary distance value uniquely matches one of the first previously determined inter-pupillary distance value and the second previously determined inter-pupillary distance value.

5. The method of claim 3, wherein if the automatically calculated inter-pupillary distance value uniquely matches one of the first previously determined inter-pupillary distance value and the second previously determined inter-pupillary distance value, automatically calibrating comprises calibrating the head mounted display device using calibration data associated with the uniquely matching previously determined inter-pupillary distance value.

6. The method of claim 3, wherein:
if the automatically calculated inter-pupillary distance value matches both the first previously determined inter-pupillary distance value and the second previously determined inter-pupillary distance value, the method further comprises determining which of the first previously determined inter-pupillary distance value and the second previously determined inter-pupillary distance value is associated with the user; and
automatically calibrating comprises calibrating the head mounted display device using calibration data associated with the previously determined inter-pupillary distance value associated with the user.

7. The method of claim 6, wherein determining which of the first previously determined inter-pupillary distance value and the second previously determined inter-pupillary distance value is associated with the user comprises:
displaying information to the user, wherein the displayed information comprises first information uniquely associated with the first user and second information uniquely associated with the second user;
determining a view direction of the user; and
detecting a selection of one of the first information and the second information by the user.

8. The method of claim 7, wherein determining the view direction of the user comprises determining one or more of a head position of the user and an eye gaze of the user.

9. The method of claim 8, wherein the displayed information comprises one or more of text and an image.

10. A head mounted display device comprising:
an eye position and tracking assembly configured to automatically calculate an inter-pupillary distance value for the user; and
a processor configured to:
compare the automatically calculated inter-pupillary distance value to a previously determined inter-pupillary distance value;
determine if the automatically calculated inter-pupillary distance value matches, within a predetermined tolerance, the preexisting inter-pupillary distance value; and
automatically calibrate the head mounted display device using calibration data associated with matching previously determined inter-pupillary distance value.

11. The head mounted display device of claim 10, wherein:
the previously determined inter-pupillary distance value comprises a first previously determined inter-pupillary distance value associated with a first user and a second previously determined inter-pupillary distance value associated with a second user; and
the processor is configured to compare the automatically calculated inter-pupillary distance value to the first previously determined inter-pupillary distance value and the second previously determined inter-pupillary distance value.

12. The head mounted display device of claim 11, wherein the processor is configured to determine if the automatically calculated inter-pupillary distance value uniquely matches one of the first previously determined inter-pupillary distance value and the second previously determined inter-pupillary distance value.

13. The head mounted display device of claim 11, wherein if the automatically calculated inter-pupillary distance value uniquely matches one of the first previously determined inter-pupillary distance value and the second previously determined inter-pupillary distance value, the processor is configured to calibrate the head mounted display device using calibration data associated with the uniquely matching previously determined inter-pupillary distance value.

14. The head mounted display device of claim 11, wherein if the automatically calculated inter-pupillary distance value matches both the first previously determined inter-pupillary distance value and the second previously determined inter-pupillary distance value, the processor is further configured to:
determine which of the first previously determined inter-pupillary distance value and the second previously determined inter-pupillary distance value is associated with the user; and
calibrate the head mounted display device using calibration data associated with the previously determined inter-pupillary distance value associated with the user.

15. The head mounted display device of claim 11, wherein the processor is further configured to:
display information to the user, wherein the displayed information comprises first information uniquely associated with the first user and second information uniquely associated with the second user;
determine a view direction of the user; and
detect a selection of one of the first information and the second information by the user.

16. An apparatus comprising:
a computer system that provides an electronic signal representing image data; and
a head-mounted display device that provides image data in response to the electronic signal, wherein the head-mounted display device includes:
an eye position and tracking assembly configured to automatically calculate an inter-pupillary distance value for the user; and
a processor configured to:
compare the automatically calculated inter-pupillary distance value to a previously determined inter-pupillary distance value;
determine if the automatically calculated inter-pupillary distance value matches, within a predetermined tolerance, the preexisting inter-pupillary distance value; and
automatically calibrate the head mounted display device using calibration data associated with matching previously determined inter-pupillary distance value.

17. The apparatus of claim 16, wherein:
the previously determined inter-pupillary distance value comprises a first previously determined inter-pupillary distance value associated with a first user and a second previously determined inter-pupillary distance value associated with a second user; and
the processor is configured to compare the automatically calculated inter-pupillary distance value to the first previously determined inter-pupillary distance value and the second previously determined inter-pupillary distance value.

18. The apparatus of claim 17, wherein the processor is configured to determine if the automatically calculated inter-pupillary distance value uniquely matches one of the first previously determined inter-pupillary distance value and the second previously determined inter-pupillary distance value.

19. The apparatus of claim 17, wherein if the automatically calculated inter-pupillary distance value uniquely matches one of the first previously determined inter-pupillary distance value and the second previously determined inter-pupillary distance value, the processor is configured to calibrate the head mounted display device using calibration data associated with the uniquely matching previously determined inter-pupillary distance value.

20. The apparatus of claim 17, wherein if the automatically calculated inter-pupillary distance value matches both the first previously determined inter-pupillary distance value and the second previously determined inter-pupillary distance value, the processor is further configured to:
determine which of the first previously determined inter-pupillary distance value and the second previously determined inter-pupillary distance value is associated with the user; and
calibrate the head mounted display device using calibration data associated with the previously determined inter-pupillary distance value associated with the user.
